(19) United States
(12) Patent Application Publication
(10) Pub. No.: US 2024/0084141 A1
(43) Pub. Date: Mar. 14, 2024

(54) BIOMAG BASED EMULSION FOR COLD-IN-PLACE APPLICATIONS

(71) Applicant: IOWA STATE UNIVERSITY RESEARCH FOUNDATION, INC., Ames, IA (US)

(72) Inventors: Eric William Cochran, Ames, IA (US); Michael J. Forrester, Ames, IA (US); Austin Hohmann, Des Moines, IA (US); Nacu Hernandez, Ames, IA (US); Baker Kuehl, Huxley, IA (US); Ronald Christopher Williams, Ames, IA (US)

(21) Appl. No.: 18/449,851

(22) Filed: Aug. 15, 2023

Related U.S. Application Data
(60) Provisional application No. 63/397,963, filed on Aug. 15, 2022.

(51) Int. Cl. C08L 95/00; E01C 19/22

(52) U.S. Cl. CPC C08L 95/005; E01C 19/22; C08L 2207/22

(57) ABSTRACT

The present application is directed to an asphalt pavement product comprising:
a reclaimed asphalt pavement product (RAP); and
an emulsified product mixed with the RAP, said emulsified product comprising:
   water;
   one or more surfactants;
   one or more stabilizers;
   one or more polymers; and
   one or more compounds of formula (I):

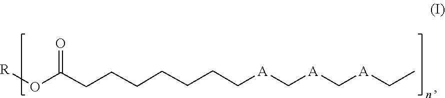

wherein R and A are as described herein. The present application is also directed to methods of paving a road course using the emulsified product.

This application claims the benefit of U.S. Provisional Patent Application Ser. No. 63/397,963, filed Aug. 15, 2022, which is hereby incorporated by reference in its entirety.

### FIELD

The present application relates to BioMAG based emulsion for cold-in-place applications.

### BACKGROUND

The global system of roads is complex and integrated, with profound social and economic influences on the lives of all. Modern civilization depends upon a network of smooth and durable pavements that can service a wide range of vehicles for decades without severe interruptions. In the US, trade and economic activity is directly correlated to the quality of highway access (Duranton et al., “Roads and Trade: Evidence from the US,” Rev. Econ. Stud. 81:681-724 (2014)). Given the vital role of transportation infrastructure, it is critical to manage both the economic and environmental costs of its maintenance and proliferation. Asphalt pavements play a major role in this: according to the Federal Highway Administration, about 94% of the 2.8 million miles of paved US roads featured an asphalt surface in 2018 (Table HM-12- Highway Statistics 2017-Policy Federal Highway Administration. (Accessed: Apr. 27, 2022)). Like concrete, asphalt pavements are incredibly energy and emissions intensive (Ma et al.,. “Rheological and Aging Characteristics of the Recycled Asphalt Binders with Different Rejuvenator Incorporation Methods,” J. Clean. Prod. 262: 121249 (2020); Hu et al., “Sustainability Innovations in Transportation Infrastructure: An Overview of the Special Volume on Sustainable Road Paving,” J. Clean. Prod. 235:369-377 (2019); Ayub et al., “Exergetic Optimization and Comparison of Combined Gas Turbine Supercritical CO2 Power Cycles,” J. Renew. Sustain. Energy 10:044703 (2018)). In 2019 the domestic asphalt paving market consumed nearly 420 million tons, representing over $15 billion in economic activity, 21 million tons of CO₂ equivalent emissions, and 80 million barrels of oil equivalent embodied energy, or about three quarts of oil and 600 pounds CO₂ for two parking stalls (Zapata et al., “Energy Consumption of Asphalt and Reinforced Concrete Pavement Materials and Construction,” J. Infrastruct. Syst. 11:9-20 (2005); Stripple, H. “Life Cycle Assessment of Road: A Pilot Study for Inventory Analysis,” Second Revised Edition. IVI. Rapp. (2001)). Clearly, there are strong incentives to reduce these costs and deleterious impacts. In addition to service life extension, improving the efficient use and reuse of raw and end-of-life materials are crucial strategies.

Reclaimed Asphalt Pavement (RAP) is produced in the demolition and resurfacing of roadways in which the asphalt pavement is milled to granular form for reuse or landfilling. RAP is composed of both aged asphalt binder and recovered aggregate, representing an enormous store of embodied energy and value. The incorporation of RAP into new hot mix asphalt (HMA) displaces virgin materials with attendant reductions in cost, energy, and emissions. In principle, most plants can produce HMA containing near 50.0 wt % RAP, with cost and energy savings exceeding 30.0% (Zahoor et al., “Sustainable Asphalt Rejuvenation Using Waste Cooking Oil: A Comprehensive Review,” J. Clean. Prod. 278:123304 (2021)). However, RAP use in 2018 reached only 21.0 wt % nationally, about 90 million tons. Pavement designs featuring higher RAP content are limited by the properties of the stiff oxidized RAP binder. That is, overuse of RAP causes embrittlement and more intensive processing conditions at the HMA plant, potentially offsetting many of the energy and emissions savings (Silva et al., “Are Totally Recycled Hot Mix Asphalts a Sustainable Alternative for Road Paving?,” Resour. Conserv. Recycl. 60:38-48 (2012)). Accordingly, only a fraction of the RAP produced each year is consumed.

The present application is directed to overcoming these and other deficiencies in the art.

### SUMMARY

One aspect of the present application relates to an asphalt pavement product comprising:
a reclaimed asphalt pavement product (RAP); and
an emulsified product mixed with the RAP, said emulsified product comprising:
   water;
   one or more surfactants;
   one or more stabilizers;
   one or more polymers; and
   one or more compounds of formula (I):

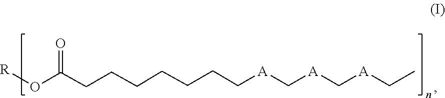

wherein:
each A is selected independently at each occurrence thereof from the group consisting of

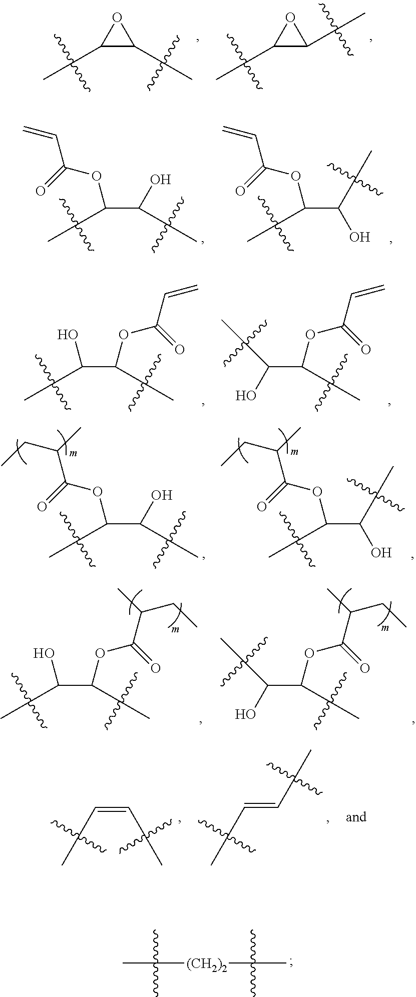

and
wherein at least one A is

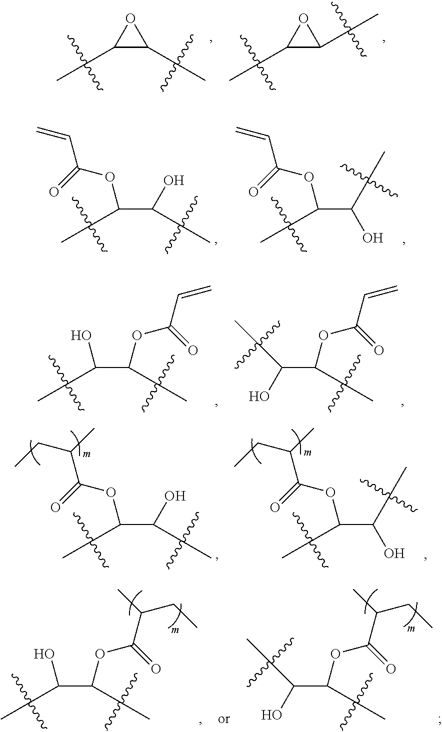

each

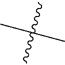

represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of

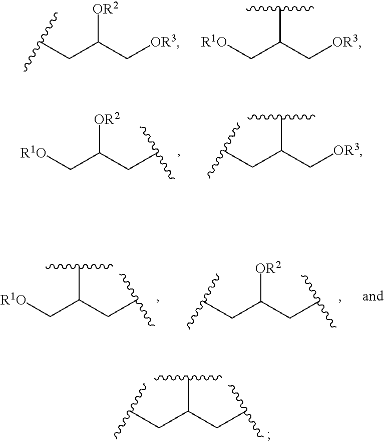

each

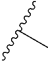

represents the point of attachment to a

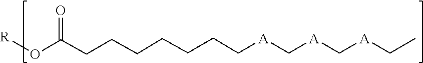

moiety;
R¹, R², and R³ are independently selected from the group consisting of —H and —C(O)R⁴;
R⁴ is H, C₁-C₂₃ alkyl, or aryl; and
   wherein the reclaimed asphalt pavement product (RAP) is present in the asphalt pavement product in an amount of from about 80 wt % to about 100 wt %.

Another aspect of the present application relates to a method of paving a road course. This method comprises:
providing a road course;
applying a layer of the asphalt pavement product of any of the embodiments described herein to the road course;
compacting the layer of the asphalt pavement product; and
curing the layer of the asphalt pavement product under conditions effective to form a paved road course.

Another aspect of the present application relates to a method of paving a road course.

This method comprises:
providing a road course;
providing a reclaimed asphalt pavement product (RAP);
applying a layer of the RAP on the road course to form a RAP layer;
applying an emulsified product on the RAP layer to form a rejuvenated RAP layer in the road course, said emulsified product comprising:
   water;
   one or more surfactants;
   one or more stabilizers;
   one or more polymers; and
   one or more compounds of formula (I):

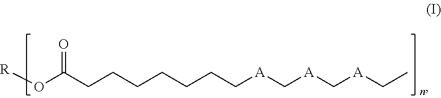

wherein:
each A is selected independently at each occurrence thereof from the group consisting of

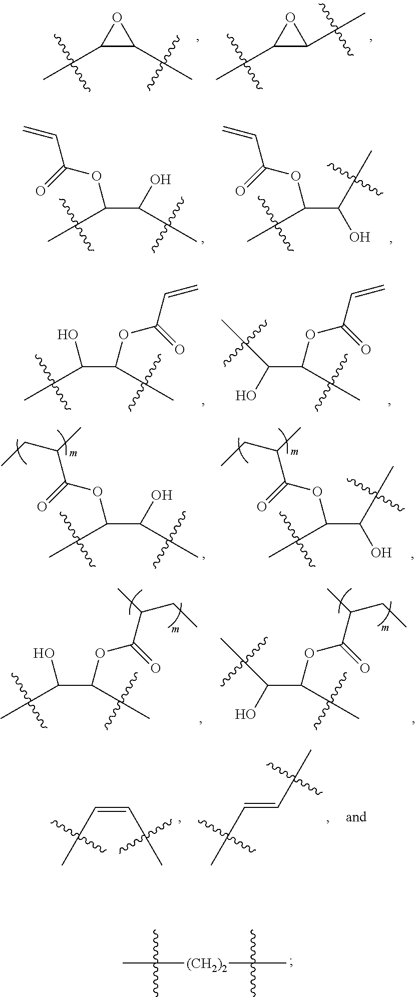

and
wherein at least one A is

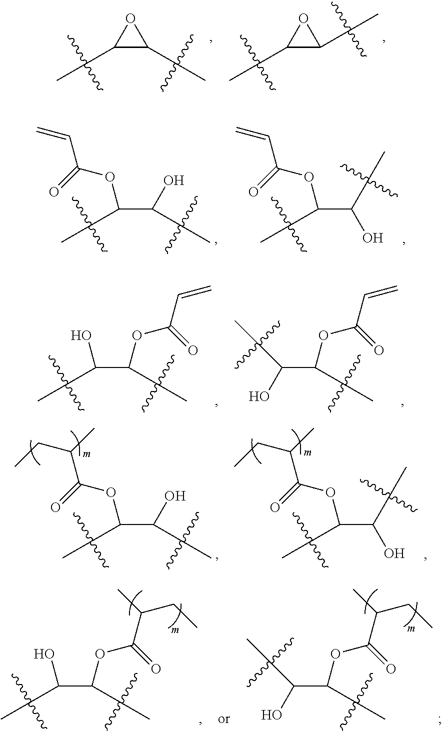

each

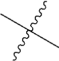

represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of

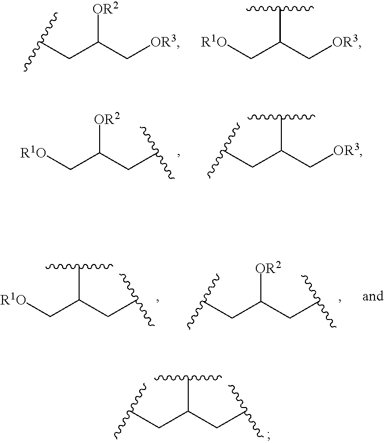

each

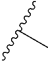

represents the point of attachment to a

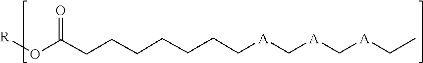

moiety;
R¹, R², and R³ are independently selected from the group consisting of —H and —C(O)R₄;
R⁴ is H, C₁-C₂₃ alkyl, or aryl;
compacting the rejuvenated RAP layer to form a rejuvenated RAP course; and
curing the rejuvenated RAP course under conditions effective to form a paved road course.

Another aspect of the present application relates to a method of paving a road course. This method comprises:
providing a road course;
providing a reclaimed asphalt pavement product (RAP);
mixing the RAP with an emulsified product to form a rejuvenated RAP mixture, said emulsified product comprising:
   water;
   one or more surfactants;
   one or more stabilizers;
   one or more polymers; and
   one or more compounds of formula (I):

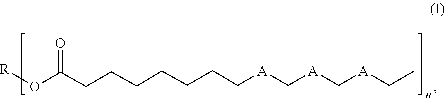

wherein:
each A is selected independently at each occurrence thereof from the group consisting of

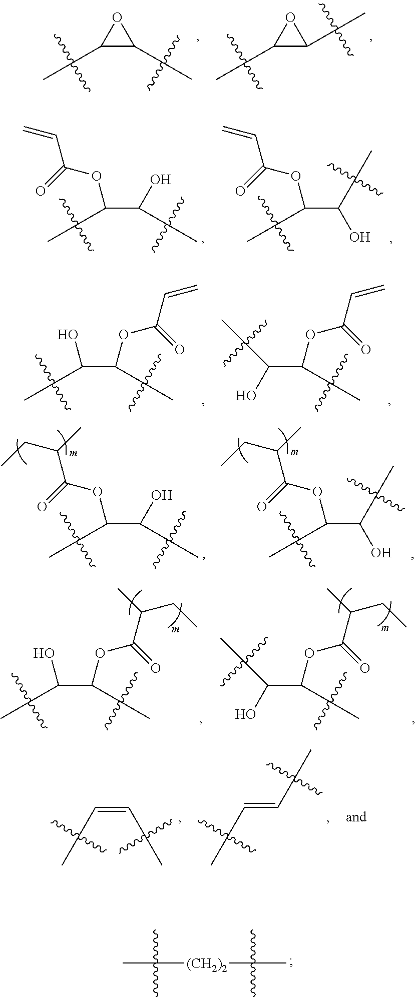

and
wherein at least one A is

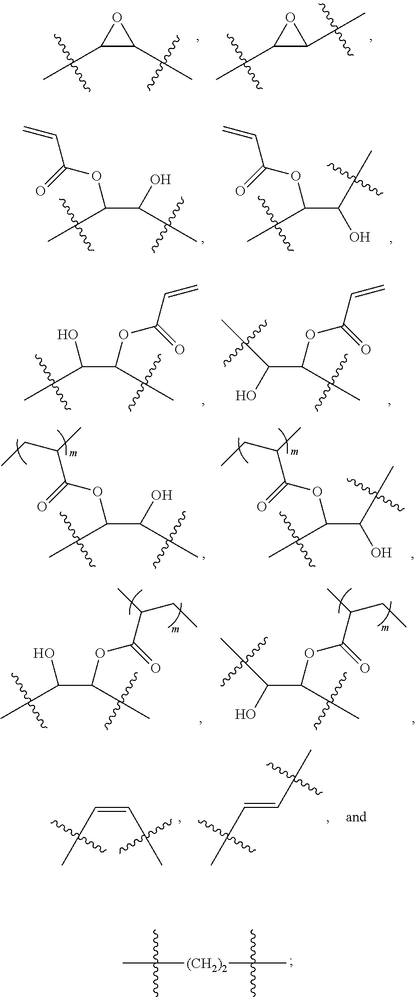

each

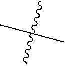

represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of

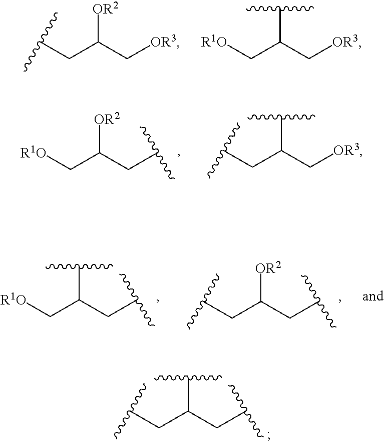

each

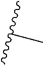

represents the point of attachment to a

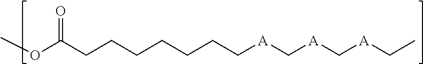

moiety;
R¹, R², and R³ are independently selected from the group consisting of —H and —C(O)R⁴;
R⁴ is H, C₁-C₂₃ alkyl, or aryl;
applying a layer of the rejuvenated RAP mixture on the road course to form a rejuvenated RAP layer;
compacting the rejuvenated RAP layer to form a rejuvenated RAP course; and
curing the rejuvenated RAP course under conditions effective to form a paved road course.

Many driveways, parking lots, exhibition grounds, multi-use trails, municipal, county, and agricultural roads face only light traffic including pedestrians, bicycles, passenger vehicles, and light trucks. Due to costs ranging from $0.5 MM to $1 MM per acre for HMA construction as of June 2022 in the US, many such surfaces remain unpaved or are allowed to attain a dangerous state of disrepair. Fortuitously, the durability afforded by HMA pavements is over-specified in many use cases, presenting opportunities for less resource-intensive alternatives like Cold-In-place Recycling (CIR). The CIR process refers to the construction of asphalt pavements featuring crushed RAP and various components, most often asphalt emulsion (Gómez-Meijide et al., “A Proposed Methodology for the Global Study of the Mechanical Properties of Cold Asphalt Mixtures,” Mater. Des. 57:520-527 (2014), which is hereby incorporated by reference in its entirety) along with fresh aggregate, fly ash, and Portland cement (Chen et al., “Microstructure of Synthetic Composite Interfaces and Verification of Mixing Order in Cold-Recycled Asphalt Emulsion Mixture,” J. Clean. Prod. 263:121467 (2020), which is hereby incorporated by reference in its entirety). Water provides fluidization to facilitate workability, while the solid components act as a reinforcing “mortar” to bind the RAP particles under the compressive forces of a compactor. The cementitious components provide strength, albeit at the cost of a lengthy curing process (Gómez-Meijide et al., “Recycled Construction and Demolition Waste in Cold Asphalt Mixtures: Evolutionary Properties,” J. Clean. Prod. 112:588-598 (2016), which is hereby incorporated by reference in its entirety). These processes drastically reduce the cost, energy, and environmental impact of paving through the elimination of heat and heavy use of RAP content (Yu et al., “Estimation and Uncertainty Analysis of Energy Consumption and CO2 Emission of Asphalt Pavement Maintenance,” J. Clean. Prod. 189:326-333 (2018), which is hereby incorporated by reference in its entirety). However, a significant fraction of virgin material is still required, particularly the asphalt binder component of asphalt emulsions and the incredibly energy-intensive Portland cement. Due to the absence of heat, the RAP granules are stiff and non-compactable, and without such fillers compaction quality is poor with a high fraction of air voids (Lee et al., “Rational Mix-Design Procedure for Cold In-Place Recycling Asphalt Mixtures and Performance Prediction” J. Mater. Civ. Eng. 28:04016008 (2016); Sebaaly et al., “Practical Method for in-Place Density Measurement of Cold in-Place Recycling Mixtures,” Constr. Build. Mater. 227: 116731 (2019), which are hereby incorporated by reference in their entirety).

The CIR process can be further improved by reducing the need for virgin materials and extensive curing times. The present application addresses these challenges through the surprising discovery that RAP compaction can be achieved with air voids far less than 10% without the provision of interstitial “mortar-like” materials. Using reactive recycling agents (RRAs), a greener and simplified CIP process is disclosed that uses only RAP with modest amounts of RRA, less than about 20% or preferably less than 10%.

### BRIEF DESCRIPTION OF THE DRAWINGS

FIG. 1 is a schematic showing various components of an asphalt pavement structure.

FIGS. 2A-B are schematics showing conventional Cold-In-place Recycling (CIP) compaction process (FIG. 2A) and compaction using the reactive recycling agents (RRAs) of the present application (FIG. 2B). In the conventional CIP compaction process, “mortar-like” deformable fillers like emulsified asphalt droplets and Portland cement are used to fill the interstices of reclaimed asphalt pavement product (RAP) granules. Compaction is greatly facilitated by the deformation of the fillers. During the compaction using the RRAs of the present application, RRA droplets penetrate the RAP granules, softening them such that they readily deform during the compaction process to achieve desirable air void contents less than about 10%.

FIGS. 3A-C are images showing application of recycling aid to pre-distributed RAP (FIG. 3A), compaction (FIG. 3B), and treated and compacted test section (FIG. 3C).

### DETAILED DESCRIPTION

One aspect of the present application relates to an asphalt pavement product comprising:
a reclaimed asphalt pavement product (RAP); and
an emulsified product mixed with the RAP, said emulsified product comprising:
   water;
   one or more surfactants;
   one or more stabilizers;
   one or more polymers; and
   one or more compounds of formula (I):

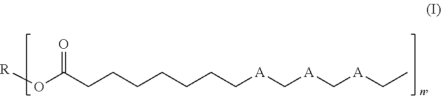

wherein:
each A is selected independently at each occurrence thereof from the group consisting of

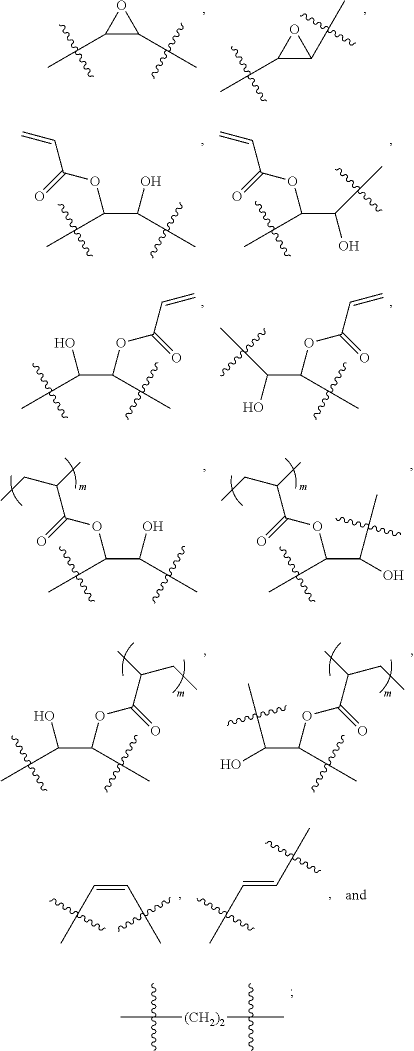

and
wherein at least one A is

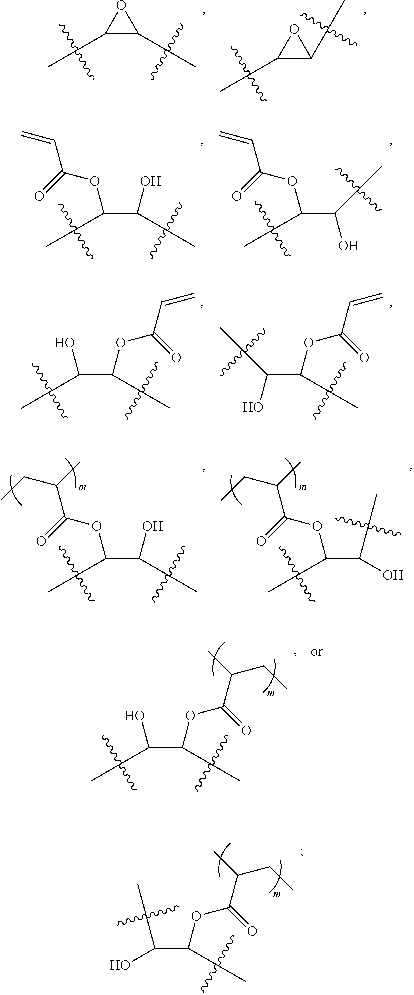

each

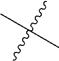

represents the point of attachment to a —CH₂— group; each
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of

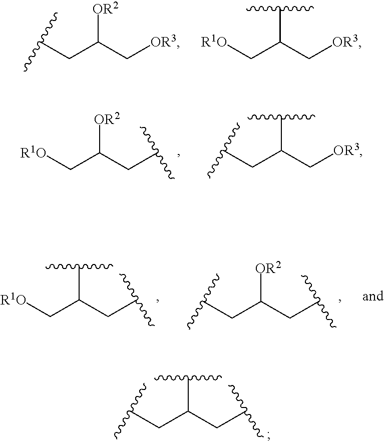

each

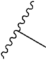

represents the point of attachment to a

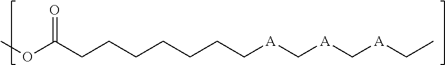

moiety;
R¹, R², and R³ are independently selected from the group consisting of —H and —C(O)R⁴;
R⁴ is H, C₁-C₂₃ alkyl, or aryl; and
   wherein the reclaimed asphalt pavement product (RAP) is present in the asphalt pavement product in an amount of from about 80 wt % to about 100 wt %.

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

The term “alkyl” means an aliphatic hydrocarbon group which may be straight or branched having about 1 to about 23 carbon atoms in the chain. For example, straight or branched carbon chain could have 1 to 10 carbon atoms. Branched means that one or more lower alkyl groups such as methyl, ethyl or propyl are attached to a linear alkyl chain. Exemplary alkyl groups include methyl, ethyl, n-propyl, i-propyl, n-butyl, t-butyl, n-pentyl, and 3-pentyl.

The term “aryl” means an aromatic monocyclic or multi-cyclic ring system of 6 to about 14 carbon atoms, preferably of 6 to about 10 carbon atoms. Representative aryl groups include phenyl and naphthyl.

The term “benzyl” means a benzyl group as shown below

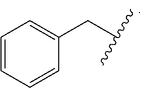 [SMILES: *Cc1ccccc1]

The term “heteroaryl” means an aromatic monocyclic or multi-cyclic ring system of about 5 to about 14 ring atoms, preferably about 5 to about 10 ring atoms, in which one or more of the atoms in the ring system is/are element(s) other than carbon, for example, nitrogen, oxygen, or sulfur. In the case of multi-cyclic ring system, only one of the rings needs to be aromatic for the ring system to be defined as “Heteroaryl”. Preferred heteroaryls contain about 5 to 6 ring atoms. The prefix aza, oxa, thia, or thio before heteroaryl means that at least a nitrogen, oxygen, or sulfur atom, respectively, is present as a ring atom. A nitrogen atom of a heteroaryl is optionally oxidized to the corresponding N-oxide. Representative heteroaryls include pyridyl, 2-oxo-pyridinyl, pyrimidinyl, pyridazinyl, pyrazinyl, triazinyl, furanyl, pyrrolyl, thiophenyl, pyrazolyl, imidazolyl, oxazolyl, isoxazolyl, thiazolyl, isothiazolyl, triazolyl, oxadiazolyl, thiadiazolyl, tetrazolyl, indolyl, isoindolyl, benzofuranyl, benzothiophenyl, indolinyl, 2-oxoindolinyl, dihydrobenzofuranyl, dihydrobenzothiophenyl, indazolyl, benzimidazolyl, benzooxazolyl, benzothiazolyl, benzoisoxazolyl, benzoisothiazolyl, benzotriazolyl, benzo[1,3]dioxolyl, quinolinyl, isoquinolinyl, quinazolinyl, cinnolinyl, pthalazinyl, quinoxalinyl, 2,3-dihydro-benzo[1,4]dioxinyl, benzo[1,2,3]triazinyl, benzo[1,2,4]triazinyl, 4H-chromenyl, indolizinyl, quinolizinyl, 6aH-thieno[2,3-d]imidazolyl, 1H-pyrrolo[2,3-b]pyridinyl, imidazo[1,2-a]pyridinyl, pyrazolo[1,5-a]pyridinyl, [1,2,4]triazolo[4,3-a]pyridinyl, [1,2,4]triazolo[1,5-a]pyridinyl, thieno[2,3-b]furanyl, thieno[2,3-b]pyridinyl, thieno[3,2-b]pyridinyl, furo[2,3-b]pyridinyl, furo[3,2-b]pyridinyl, thieno[3,2-d]pyrimidinyl, furo[3,2-d]pyrimidinyl, thieno[2,3-b]pyrazinyl, imidazo[1,2-a]pyrazinyl, 5,6,7,8-tetrahydroimidazo[1,2-a]pyrazinyl, 6, 7-dihydro-4H-pyrazolo[5,1-c][1,4]oxazinyl, 2-oxo-2,3-dihydrobenzo[d]oxazolyl, 3,3-dimethyl-2-oxoindolinyl, 2-oxo-2,3-dihydro-1H-pyrrolo[2,3-b]pyridinyl, benzo[c][1,2,5]oxadiazolyl, benzo[c][1,2,5]thiadiazolyl, 3,4-dihydro-2H-benzo[b][1,4]oxazinyl, 5,6,7,8-tetrahydro-[1,2,4]triazolo[4,3-a]pyrazinyl, [1,2,4]triazolo[4,3-a]pyrazinyl, 3-oxo-[1,2,4]triazolo[4,3-a]pyridin-2(3H)-yl, and the like.

As used herein, “heterocyclyl” or “heterocycle” refers to a stable 3- to 18-membered ring (radical) which consists of carbon atoms and from one to five heteroatoms selected from the group consisting of nitrogen, oxygen and sulfur. For purposes of this application, the heterocycle may be a monocyclic, or a polycyclic ring system, which may include fused, bridged, or spiro ring systems; and the nitrogen, carbon, or sulfur atoms in the heterocycle may be optionally oxidized; the nitrogen atom may be optionally quaternized; and the ring may be partially or fully saturated. Examples of such heterocycles include, without limitation, oxiranyl, azepinyl, azocanyl, pyranyl dioxanyl, dithianyl, 1,3-dioxolanyl, tetrahydrofuryl, dihydropyrrolidinyl, decahydroisoquinolyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, 2-oxoazepinyl, oxazolidinyl, oxiranyl, piperidinyl, piperazinyl, 4-piperidonyl, pyrrolidinyl, pyrazolidinyl, thiazolidinyl, tetrahydropyranyl, thiamorpholinyl, thiamorpholinyl sulfoxide, and thiamorpholinyl sulfone. Further heterocycles and heteroaryls are described in Katritzky et al., eds., Comprehensive Heterocyclic Chemistry: The Structure, Reactions, Synthesis and Use of Heterocyclic Compounds, Vol. 1-8, Pergamon Press, N.Y. (1984), which is hereby incorporated by reference in its entirety.

The term “monocyclic” used herein indicates a molecular structure having one ring.

The term “polycyclic” or “multi-cyclic” used herein indicates a molecular structure having two or more rings, including, but not limited to, fused, bridged, or spiro rings.

The term “substituted” or “substitution” of an atom means that one or more hydrogen on the designated atom is replaced with a selection from the indicated group, provided that the designated atom's normal valency is not exceeded.

The term “optionally substituted” is used to indicate that a group may have a substituent at each substitutable atom of the group (including more than one substituent on a single atom), provided that the designated atom's normal valency is not exceeded, and the identity of each substituent is independent of the others. Up to three H atoms in each residue are replaced with alkyl, halogen, haloalkyl, hydroxy, loweralkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, heteroaryl, phenoxy, benzyloxy, or heteroaryloxy.

“Unsubstituted” atoms bear all of the hydrogen atoms dictated by their valency. When a substituent is keto (i.e., ═O), then two hydrogens on the atom are replaced. Combinations of substituents and/or variables are permissible only if such combinations result in stable compounds; by “stable compound” or “stable structure” is meant a compound that is sufficiently robust to survive isolation to a useful degree of purity from a reaction mixture, and formulation into an efficacious therapeutic agent.

The term “epoxide” or “oxirane” includes an epoxide ring (i.e., group) as shown below:

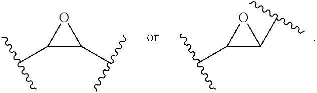 [SMILES: *C1OC1* ; *C1OC1*]

An asphalt pavement product according to the present application can utilize the reclaimed asphalt pavement product (RAP) in any form.

Reclaimed Asphalt Pavement (RAP) is produced in the demolition and resurfacing of roadways in which the asphalt pavement is milled to granular form for reuse or landfilling. Asphalt pavement can be removed from a paved surface by any process known in the art including, but not limited to, rotomilling, scraping, and scarifying. RAP is composed of both aged asphalt binder and recovered aggregate. Often the asphalt and aggregates have undergone various physical changes during construction and service. RAP can be reprocessed and reused in new asphalt materials.

RAP is created by the grinding, milling, planing, or crushing of the existing pavement. RAP can be fractionated by crushing and selecting particles below a specific particle size. Depending on the process the RAP material may be further processed through a screening and crushing operation. For example, RAP can be fed into a small impact crusher, and the resulting material can be sent across one or more sieves or screens to separate out particles above a specific size. Oversized material can be returned to the crusher and crushed again. Alternatively, RAP can be screened before being crushed.

For example, RAP can be sent through a 38.1-mm (1 ½-inch) sieve. Alternatively, a 31.75-mm (1 ¼-inch) sieve, a 25.4-mm (1-inch) sieve, a 19.0-mm (¾-inch) sieve, a 12.5-mm (½-inch) sieve, a 9.5-mm (⅜-inch) sieve, a 6.3-mm (¼-inch) sieve, or a 3.35-mm (⅛-inch) sieve can be used. These result in RAP particles having less than 1 ½ inches in diameter, less than 1 ¼ inches in diameter, less than 1 inch in diameter, less than ¾ inch in diameter, less than ½ inches in diameter, less than ⅜ inches in diameter, less than ¼ inches in diameter, less than about ⅛ inches in diameter, respectively.

RAP can be selected to include only RAP particles having a specific size or particles having a specific size range. In some embodiments, the RAP is used in the form of millings. Suitable milling size of RAP millings that can be used is from about 0.25 inch diameter millings to about 1.5 inch diameter millings. Preferably, RAP is provided in the form of 0.5 to 1 inch diameter millings.

The asphalt pavement product according to the present application can contain from about 80 wt % to about 100 wt % of the reclaimed asphalt pavement (RAP). For example, the asphalt pavement product according to the present application can contain RAP in the amount of from about 80.0 wt % to about 99.9 wt %, about 80.0 wt % to about 99.5 wt %, about 80.0 wt % to about 99.0 wt %, about 80.0 wt % to about 98.0 wt %, about 80.0 wt % to about 97.0 wt %, about 80.0 wt % to about 96.0 wt %, about 80.0 wt % to about 95.0 wt %, about 80.0 wt % to about 94.0 wt %, about 80.0 wt % to about 93.0 wt %, about 80.0 wt % to about 92.0 wt %, about 80.0 wt % to about 91.0 wt %, about 80.0 wt % to about 90.0 wt %, about 80.0 wt % to about 89.0 wt %, about 80.0 wt % to about 88.0 wt %, about 80.0 wt % to about 87.0 wt %, about 80.0 wt % to about 86.0 wt %, about 80.0 wt % to about 85.0 wt %, about 80.0 wt % to about 84.0 wt %, about 80.0 wt % to about 83.0 wt %, about 80.0 wt % to about 82.0 wt %, about 80.0 wt % to about 81.0 wt %, 82.0 wt % to about 99.9 wt %, about 82.0 wt % to about 99.5 wt %, about 82.0 wt % to about 99.0 wt %, about 82.0 wt % to about 98.0 wt %, about 82.0 wt % to about 96.0 wt %, about 82.0 wt % to about 94.0 wt %, about 82.0 wt % to about 92.0 wt %, about 82.0 wt % to about 90.0 wt %, about 82.0 wt % to about 88.0 wt %, about 82.0 wt % to about 86.0 wt %, about 82.0 wt % to about 84.0 wt %, 84.0 wt % to about 99.9 wt %, about 84.0 wt % to about 99.5 wt %, about 84.0 wt % to about 99.0 wt %, about 84.0 wt % to about 98.0 wt %, about 84.0 wt % to about 96.0 wt %, about 84.0 wt % to about 94.0 wt %, about 84.0 wt % to about 92.0 wt %, about 84.0 wt % to about 90.0 wt %, about 84.0 wt % to about 88.0 wt %, about 84.0 wt % to about 86.0 wt %, 86.0 wt % to about 99.9 wt %, about 86.0 wt % to about 99.5 wt %, about 86.0 wt % to about 99.0 wt %, about 86.0 wt % to about 98.0 wt %, about 86.0 wt % to about 96.0 wt %, about 86.0 wt % to about 94.0 wt %, about 86.0 wt % to about 92.0 wt %, about 86.0 wt % to about 90.0 wt %, about 86.0 wt % to about 88.0 wt %, 88.0 wt % to about 99.9 wt %, about 88.0 wt % to about 99.5 wt %, about 88.0 wt % to about 99.0 wt %, about 88.0 wt % to about 98.0 wt %, about 88.0 wt % to about 96.0 wt %, about 88.0 wt % to about 94.0 wt %, about 88.0 wt % to about 92.0 wt %, about 88.0 wt % to about 90.0 wt %, 90.0 wt % to about 99.9 wt %, about 90.0 wt % to about 99.5 wt %, about 90.0 wt % to about 99.0 wt %, about 90.0 wt % to about 98.0 wt %, about 90.0 wt % to about 96.0 wt %, about 90.0 wt % to about 94.0 wt %, about 90.0 wt % to about 92.0 wt %, 92.0 wt % to about 99.9 wt %, about 92.0 wt % to about 99.5 wt %, about 92.0 wt % to about 99.0 wt %, about 92.0 wt % to about 98.0 wt %, about 92.0 wt % to about 96.0 wt %, about 92.0 wt % to about 94.0 wt %, 94.0 wt % to about 99.9 wt %, about 94.0 wt % to about 99.5 wt %, about 94.0 wt % to about 99.0 wt %, about 94.0 wt % to about 98.0 wt %, about 94.0 wt % to about 96.0 wt %, about 95.0 wt % to about 99.9 wt %, about 95.0 wt % to about 99.5 wt %, about 95.0 wt % to about 99.0 wt %, about 95.0 wt % to about 98.5 wt %, about 95.0 wt % to about 98.0 wt %, about 95.0 wt % to about 97.5 wt %, about 95.0 wt % to about 97.0 wt %, about 95.0 wt % to about 96.5 wt %, about 95.0 wt % to about 96.0 wt %, about 95.0 wt % to about 95.5 wt %, about 96.0 wt % to about 99.9 wt %, about 96.0 wt % to about 99.0 wt %, about 96.0 wt % to about 98.5 wt %, about 96.0 wt % to about 98.0 wt %, about 96.0 wt % to about 97.5 wt %, about 96.0 wt % to about 97.0 wt %, about 96.0 wt % to about 96.5 wt %, about 97.0 wt % to about 99.9 wt %, about 97.0 wt % to about 99.0 wt %, about 97.0 wt % to about 98.5 wt %, about 97.0 wt % to about 98.0 wt %, about 97.0 wt % to about 97.5 wt %, about 98.0 wt % to about 99.9 wt %, about 98.0 wt % to about 99.0 wt %, or about 98.0 wt % to about 98.5 wt %.

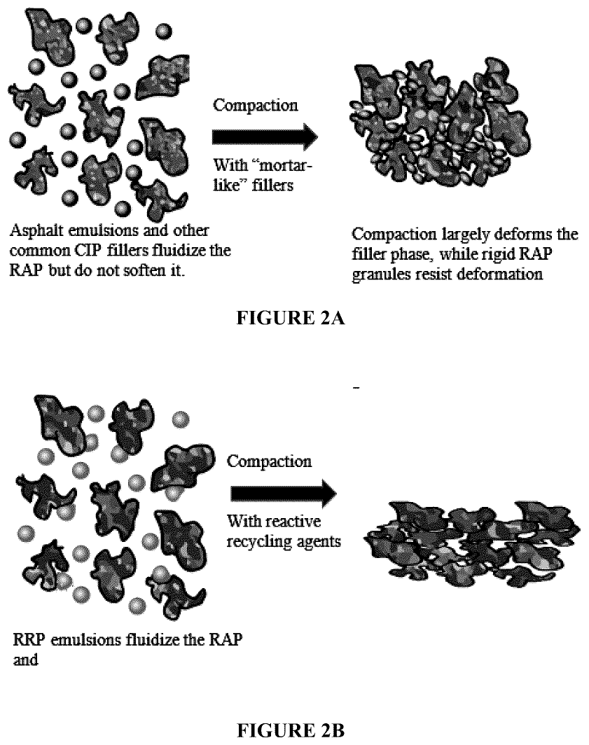

The term, a reactive recycling agent (RRA) refers to an oil-in-water emulsion where the oil phase comprises a partially epoxidized triglyceride and a branched chain thermoplastic poly(acrylated epoxidized triglyceride). Partially epoxidized triglyceride-based oils of Formula I, like sub-epoxidized soybean oil (SESO), with oxirane values between about 2 and 3 wt %, are particularly effective as asphalt rejuvenators that chemically bond with the oxidized asphaltene moieties present in RAP asphalt binder. Branched chain thermoplastic poly(acrylated epoxidized triglyceride) polymers of Formula II like poly(acrylated epoxidized high oleic soybean oil) (PAEHOSO) are readily solvated in oils like SESO, and greatly improve the cohesion and strength of RAP. As illustrated in FIG. 2A, when RRAs are mixed with RAP, the active ingredients like SESO and PAEHOSO absorb into the RAP, temporarily softening it. This softening effect permits the realization of low air void pavements upon compaction. Moreover, the plasticized RAP granules become self-cohesive such that the compressive forces effectuate the fusion of the RAP binder on adjacent granules, facilitating the development of a continuous binder matrix. The reactive nature of the SESO and PAEHOSO, driven by asphalt chemical interactions with oxirane and acrylic moieties reverses the softening effect post-compaction and permits use of the paved surface once it has dried.

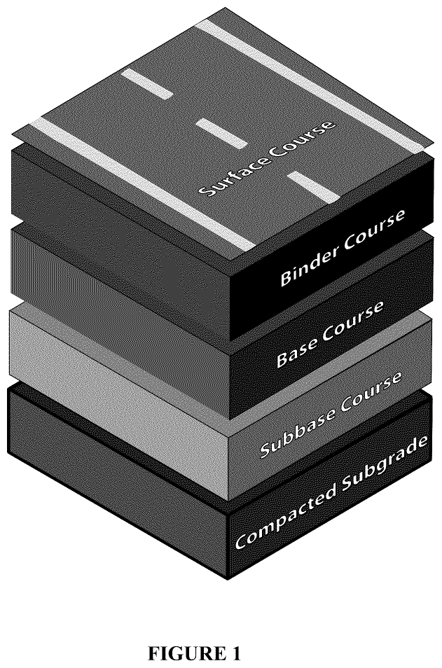

As illustrated in FIG. 1, asphalt pavements are multilayered structures with compacted subgrade (compacted soil) at the bottom with additional layers as indicated by the pavement design, terminating with the pavement surface. Optional base and subbase courses distribute the load applied by the pavement layers to the subgrade layer and provide drainage. Ordinarily, the subbase and base layers consist of hard and durable aggregates. RRA/RAP mixtures may be used to construct one or more binder courses and can additionally be used to construct a surface course. An RRA/RAP course can first be prepared by providing an RRA/RAP mixture, spreading the mixture onto a prepared base course or subgrade, and compacting the mixture to yield the completed pavement course. Alternatively, an RRA/RAP course can be obtained by providing RAP, spreading it onto a prepared base course or subgrade, applying the RRA onto the RAP, and then compacting the RRA/RAP mixture to form the completed pavement course.

One embodiment of the present application relates to an RRA product suitable for the Cold-In-place Recycling (CIP) construction process. The emulsion consists of water; one or more surfactants, present at 0.05 to 20 wt %; one or more partially epoxidized oils of Formula I, ranging from 1 wt % to 75 wt %; and one or more branched chain thermoplastic poly(acrylated epoxidized triglyceride) polymers of Formula II, ranging from 1 wt % to 75 wt %. When combined these components form an emulsion.

In another embodiment the RRA product may optionally include any of the following: one or more binders, one or more asphalt emulsions, one or more polymers, one or more colorants, one or more antimicrobials, one or more stabilizing or gelling agents, one or more crosslinkers, one or more antistripping agents, one or more wetting agents, and combinations thereof.

Another embodiment of the present application is an RRA/RAP product, wherein RAP granules are thoroughly mixed with the RRA.

Another embodiment of the present application is a method of producing the RRA/RAP product disclosed herein.

Another embodiment of the present application is an RRA/RAP pavement course made from the RRA/RAP product disclosed herein.

Another embodiment of the present application is a method of constructing a pavement course using the RRA/RAP product disclosed herein.

The asphalt pavement product according to the present application can contain from about 0 wt % to about 5 wt % of one or more surfactants. For example, the asphalt pavement product of the present application can contain one or more surfactants in the amount of from about 0.01 wt % to about 5 wt %, about 0.01 wt % to about 4 wt %, about 0.01 wt % to about 3 wt %, about 0.1 wt % to about 3 wt %, about 0.2 wt % to about 3 wt %, about 0.3 wt % to about 3 wt %, about 0.4 wt % to about 3 wt %, about 0.5 wt % to about 3 wt %, about 0.6 wt % to about 3 wt %, about 0.7 wt % to about 3 wt %, about 0.8 wt % to about 3 wt %, about 0.9 wt % to about 3 wt %, about 1 wt % to about 3 wt %, about 0.01 wt % to about 2 wt %, about 0.1 wt % to about 2 wt %, about 0.2 wt % to about 2 wt %, about 0.3 wt % to about 2 wt %, about 0.4 wt % to about 2 wt %, about 0.5 wt % to about 2 wt %, about 0.6 wt % to about 2 wt %, about 0.7 wt % to about 2 wt %, about 0.8 wt % to about 2 wt %, about 0.9 wt % to about2 wt %, about 1 wt % to about 2 wt %, about 0.01 wt % to about 1 wt %, about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt %, about 0.8 wt % to about 1 wt %, or about 0.9 wt % to about 1 wt %.

Suitable surfactants that can be used according to the present application include cationic emulsifying agents, anionic emulsifying agents, nonionic emulsifying agents, lecithin, and a combination thereof.

In some embodiments, the cationic emulsifying agents of any embodiments described herein are selected from the group consisting of fatty diamines, polyamines, modified tallow amines, N-(3-dimethylaminopropyl) lauroyl amide, N-(3-dimethylaminopropyl) myristoyl amide, N-(3-dimethylaminopropyl) Pal Michiruamido, N-(3-dimethylaminopropyl) stearoyl amide, N-(3-dimethylaminopropyl) oleoyl amide, N-(3-dimethylaminopropyl) linoleic Amide, N-(3-dimethylaminopropyl) linoleinamide, N-(3-diethylaminopropyl) lauroylamide, N-(3-diethylaminopropyl) myristoylamide, N-(3-diethylaminopropyl) palmitoylamide, N-(3-diethylaminopropyl) stearoylamide, N-(3-diethylaminopropyl) oleoylamide, N-(3-diethylaminopropyl) linoleamide, N-(3-diethylaminopropyl) linoleinamide, N-(3-dibutylaminopropyl) lauroylamide, N-(3-dibutylaminopropyl) myristoylamide, N-(3-dibutylaminopropyl) palmitoylamide, N-(3-dibutylaminopropyl) stearoyl amide, N-(3-dibutyl aminopropyl) oleoyl amide N-(3-dibutyl aminopropyl) linoleic amide, N-(3-dibutyl aminopropyl) Reno Lane amide, REDICOTER® E-7000, REDICOTER® E-9, REDICOTER® E-70, and a combination thereof.

In some embodiments, the anionic emulsifying agents of any embodiments described herein are selected from the group consisting of petroleum sulfonates and sulfates, soap-type emulsifying agents, alkyl metal salts of higher fatty acids, fatty acid soaps (including lauric, myristic, palmitic, oleic, ricinoleic, linoleic acids and the like, mixtures of acids available from animal or vegetable oils), REDICOTER® E-7600, REDICOTER® E-7000, and a combination thereof.

In some embodiments, the non-ionic emulsifying agents of any embodiments described herein are selected from the group consisting of ethoxylated alcohols, alkyl phenol ethoxylates, REDICOTER® EM33, ASFIER® N-400LN, TERGITOL NP-40, TERGITOL NP-70, and a combination thereof.

The asphalt pavement product according to the present application can contain from about 0 wt % to about 5 wt % of one or more polymers. For example, the asphalt pavement product of the present application can contain one or more polymers in the amount of from about 0.01 wt % to about 5 wt %, about 0.01 wt % to about 4 wt %, about 0.01 wt % to about 3 wt %, about 0.1 wt % to about 3 wt %, about 0.2 wt % to about 3 wt %, about 0.3 wt % to about 3 wt %, about 0.4 wt % to about 3 wt %, about 0.5 wt % to about 3 wt %, about 0.6 wt % to about 3 wt %, about 0.7 wt % to about 3 wt %, about 0.8 wt % to about 3 wt %, about 0.9 wt % to about 3 wt %, about 1 wt % to about 3 wt %, about 0.01 wt % to about 2 wt %, about 0.1 wt % to about 2 wt %, about 0.2 wt % to about 2 wt %, about 0.3 wt % to about 2 wt %, about 0.4 wt % to about 2 wt %, about 0.5 wt % to about 2 wt %, about 0.6 wt % to about 2 wt %, about 0.7 wt % to about 2 wt %, about 0.8 wt % to about 2 wt %, about 0.9 wt % to about2 wt %, about 1 wt % to about 2 wt %, about 0.01 wt % to about 1 wt %, about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt %, about 0.8 wt % to about 1 wt %, or about 0.9 wt % to about 1 wt %.

Suitable polymers that can be used include styrene butadiene copolymers, Elvaloy® 741 Copolymer, Elvaloy® AC1125 Acrylate Copolymer, Elvaloy® AC 12024S Acrylate Copolymer, Elvaloy® AC 1218 Acrylate Copolymer, Elvaloy® AC 1224 Acrylate Copolymer, Elvaloy® AC 1330 Acrylate Copolymer, Elvaloy® AC 1609 Acrylate Copolymer, Elvaloy® AC 1820 Acrylate Copolymer, Elvaloy® AC 2116 Acrylate Copolymer, Elvaloy® AC 2615 Acrylate Copolymer, Elvaloy® AC 2618 Acrylate Copolymer, Elvaloy® AC 3427 Acrylate Copolymer, Elvaloy® 4170 Copolymer, Elvaloy® 4924 Copolymer, Elvaloy® 5160 Copolymer, Elvaloy® 5170 Copolymer, Elvaloy® 742 Copolymer, Elvaloy® HP4051 Copolymer, Elvaloy® HP441 Copolymer, Elvaloy® HP661 Copolymer, Elvaloy® PTW Copolymer, Elvaloy® AC 34035 Copolymer, Elvaloy® HP662 Copolymer, Elvaloy® AC 2103 Acrylate Copolymer, polyethylene, cross-linked polyethylene, polypropylene, polybutadiene, polyisoprene, polyethylene terephthalate, polyvinyl alcohol, butyl acrylate, ethyl acrylate, methyl acrylate, polyacetic acid copolymers, homopolymers or copolymers of poly(acrylated epoxidized triglycerides), and a combination thereof. Preferably, the one or more polymers is selected from the group consisting of styrene butadiene copolymers, polyethylene, cross-linked polyethylene, polypropylene, polybutadiene, polyisoprene, polyethylene terephthalate, polyvinyl alcohol, butyl acrylate, ethyl acrylate, methyl acrylate, polyacetic acid copolymers, poly(acrylated epoxidized triglycerides), and a combination thereof.

The asphalt pavement product according to the present application can contain from about 0 wt % to about 5 wt % of one or more compounds of formula (I). For example, the asphalt pavement product of the present application can contain one or more compounds of formula (I) in the amount of from about 0.01 wt % to about 5 wt %, about 0.01 wt % to about 4 wt %, about 0.01 wt % to about 3 wt %, about 0.1 wt % to about 3 wt %, about 0.2 wt % to about 3 wt %, about 0.3 wt % to about 3 wt %, about 0.4 wt % to about 3 wt %, about 0.5 wt % to about 3 wt %, about 0.6 wt % to about 3 wt %, about 0.7 wt % to about 3 wt %, about 0.8 wt % to about 3 wt %, about 0.9 wt % to about 3 wt %, about 1 wt % to about 3 wt %, about 0.01 wt % to about 2 wt %, about 0.1 wt % to about 2 wt %, about 0.2 wt % to about 2 wt %, about 0.3 wt % to about 2 wt %, about 0.4 wt % to about 2 wt %, about 0.5 wt % to about 2 wt %, about 0.6 wt % to about 2 wt %, about 0.7 wt % to about 2 wt %, about 0.8 wt % to about 2 wt %, about 0.9 wt % to about2 wt %, about 1 wt % to about 2 wt %, about 0.01 wt % to about 1 wt %, about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt %, about 0.8 wt % to about 1 wt %, or about 0.9 wt % to about 1 wt %.

The compounds of formula (I) described herein may contain one or more epoxide (oxirane) rings, and unless specified otherwise, it is intended that the compounds include both cis- or trans- isomers and mixtures thereof. When the one or more compounds of formula (I) described herein contain olefinic double bonds or other centers of geometric asymmetry, and unless specified otherwise, it is intended that the compounds include both E and Z geometric isomers.

In one embodiment, the one or more compounds of formula (I) is the compound of any one of Formulae (Ia)-(Ik) or any combination thereof:

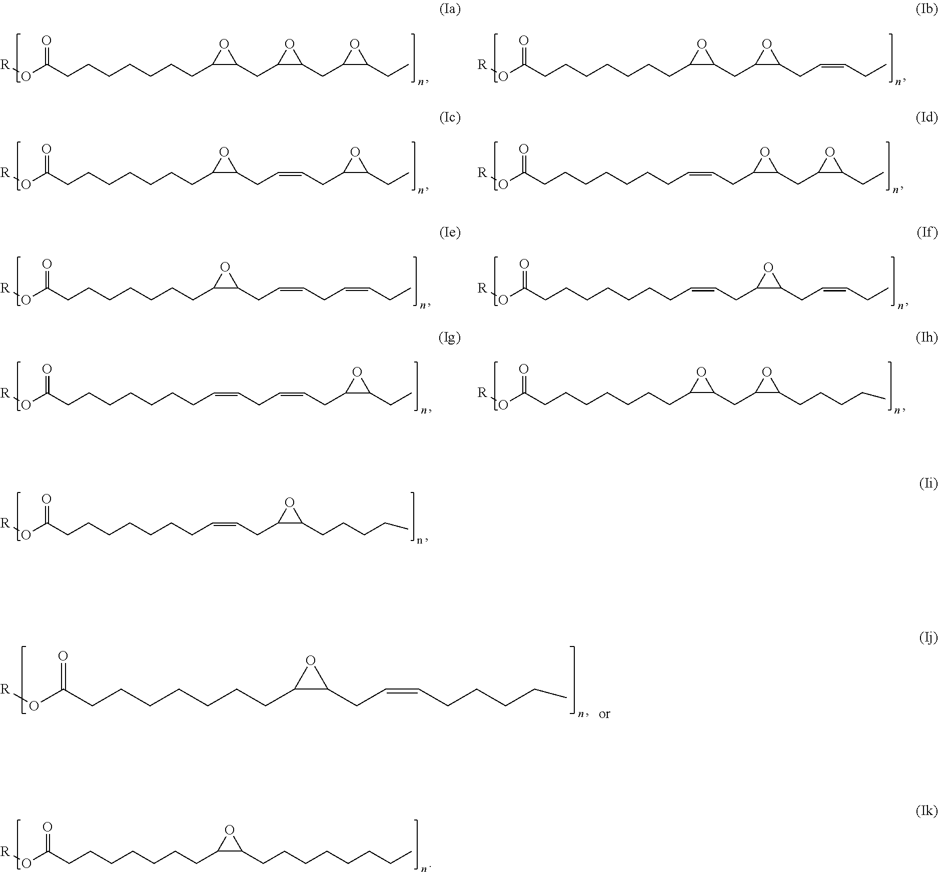

In one embodiment, the one or more compounds of formula (I) is an epoxidized vegetable oil, the epoxidized fatty acid, and/or the epoxidized fatty ester may be, in some embodiments, a mixture of a vegetable oil, a fatty acid, and/or a fatty ester. The mixture may include any combination of vegetable oil, a fatty acid, and/or a fatty ester and any combination of an epoxidized vegetable oil, the epoxidized fatty acid, and/or the epoxidized fatty ester. The mixture may further include any combination of a non-epoxidized vegetable oil, non-epoxidized fatty acid, non-epoxidized fatty ester, or a mixture thereof. In one embodiment, the mixture further comprises one or more of compounds of Formulae (IIa)-(IIc):

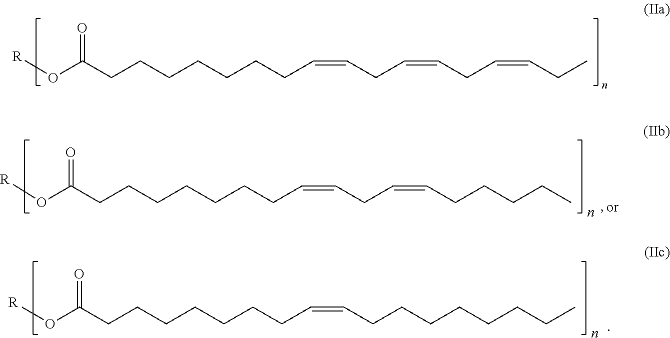

Renewable source derived fats and oils include algal oil, animal fat, beef tallow, borneo tallow, butterfat, camelina oil, candlefish oil, canola oil, castor oil, cocoa butter, cocoa butter substitutes, coconut oil, cod-liver oil, colza oil, coriander oil, corn oil, cottonseed oil, false flax oil, flax oil, float grease from wastewater treatment facilities, hazelnut oil, hempseed oil, herring oil, illipe fat, jatropha oil, kokum butter, lanolin, lard, linseed oil, mango kernel oil, marine oil, meadowfoam oil, menhaden oil, microbial oil, milk fat, mowrah fat, mustard oil, mutton tallow, neat's foot oil, olive oil, orange roughy oil, palm oil, palm kernel oil, palm kernel olein, palm kernel stearin, palm olein, palm stearin, peanut oil, phulwara butter, pile herd oil, pork lard, radish oil, ramtil oil, rapeseed oil, rice bran oil, safflower oil, sal fat, salicornia oil, sardine oil, sasanqua oil, sesame oil, shea fat, shea butter, soybean oil, sunflower seed oil, tall oil, tallow, tigernut oil, tsubaki oil, tung oil, triacylglycerols, triolein, used cooking oil, vegetable oil, walnut oil, whale oil, white grease, yellow grease, and derivatives, conjugated derivatives, genetically-modified derivatives, and mixtures of any thereof. In one embodiment, the compound of formula (I) is derived from sources selected from the group consisting of fish oil, animal oil, vegetable oil, synthetic and genetically-modified plant oils, and mixtures thereof. Examples of vegetable oil include high erucic acid rapeseed oil, safflower oil, canola oil, castor oil, sunflower oil, and linseed oil. In another embodiment, the compound of formula (I) is derived from a source other than soybean oil or corn oil.

In some embodiments, the compound of formula (I) is selected from the group consisting of sub-epoxidized soybean oil (SESO), acrylated epoxidized soybean oil (AESO), epoxidized methyl soyate (EMS), poly(acrylated epoxidized high oleic soybean oil) (PAEHOSO), poly(acrylated epoxidized soybean oil) (PAESO), and a combination thereof.

The oxirane oxygen content (also referred to herein as % oxirane oxygen or wt % of oxirane) of the one or more compounds of formula (I) may be determined by using Official Method, Standard Cd 9-57 of the American Oil Chemists' Society (“Oxirane Oxygen in Epoxidized Materials” Official Method Cd 9-57 by the American Oil Chemist' Society (Reapproved 2017), which is hereby incorporated by reference in its entirety.

$$Oxirane oxygen , \% = \frac{mL HBr to ritrate test portion \times M \times 1.6}{mass of test portion , g} \qquad Equation 1$$

$$Where - M = Molarity of HBr solution$$

For example, the oxirane oxygen content for the one or more compounds of formula (I) may be about 7.2%. In an embodiment, the oxirane oxygen content for the one or more compounds of formula (I) may be about 4.5%. The functionality is the number of epoxide groups per molecule. The functionality of the one or more compounds of formula (I) in accordance with the present application may be about 4.5 or may be about 2.1. In one embodiment, the one or more compounds of formula (I) in accordance with the present invention may contain between 0.1 wt % and 10 wt % of oxirane. For example, the wt % of oxirane may be about 0.5, about 1, about 2, about 3, about 4, about 5, about 6, about 7, about 8, about 9, or about 10 wt %. In one embodiment, the one or more compounds of formula (I) contains about 0.1-6.5 wt % of oxirane. In another embodiment, the one or more compounds of formula (I) contains about 2.5-4.5 wt % of oxirane.

Common vegetable oils all possess some degree of unsaturation in the form of allylic double bonds, which can be quantified as

$${N}_{d , 0} = \frac{moles double bonds}{moles triglyceride}$$

an unmodified oil or N_{d} for a chemically modified oil. As the oils are epoxidized, the degree of epoxidation

$${N}_{e} = \frac{moles oxirane}{moles triglyceride}$$

increases while Na decreases such that N_{d}+Nₑ=N_{d,0}. Presently, commercially available epoxidized vegetable oils (EVOs) EVOs are prepared for maximal Nₑ values, such that Nₑ˜N_{d,0} and N_{d}<<1. For example, epoxidized soybean oils (ESO) such as Arkema VikoflexR 7170 feature minimum oxirane values of 7%, corresponding to Nₑ˜4.2 and N_{d}˜0.3. The chemical reactivity, polarity, and viscosity of EVOs is well known to increase monotonically with the value of Nₑ, which can be measured via titration, through photospectroscopic techniques, or NMR.

EVO secondary oxiranes are desirable for their propensity to undergo coupling reactions with the acid groups of oxidized moieties in aged bituminous pavements and shingles. The adducts formed stabilize the aged species and prevent their agglomeration which is responsible for much of the embrittlement suffered by weatherized paving and roofing installations. In principle, the degree of reactivity with the asphalt increases with Nevalue. This consideration suggests that maximal Nₑ values, as commercially prepared EVOs offer, are desirable.

However, the viscosity and polarity of EVOs in maintenance and preservation products also impact performance. If the viscosity becomes too high, it becomes impractical to bring the EVO in contact with as asphalt surface or shingle. Moreover, the speed with which EVO droplets can penetrate an asphalt surface decreases dramatically with increasing viscosity. For this reason, fully epoxidized ESO is unsuitable for the present application. The polarity of the EVO strongly influences the miscibility with resinous binders. Non-epoxidized oils are the least polar and thus most miscible with non-oxidized asphalts. As the asphalt ages, it becomes slightly polar, and thus EVOs with intermediate Nₑ values become most preferential from a solubility perspective. If Ne is too large, however, the solubility once again decreases. For example, commercially available ESO is only partially miscible was asphalt.

Therefore, surprisingly, there exist optimal ranges of Nₑ values that balance these various considerations for the performance of the claimed inventions. The precise optimal value will vary depending on the specific vegetable oil used, the environmental conditions of the application, the condition of the pavement or roofing system, and the method of application. Here, an Nₑ value greater than about 1.0 and an N_{d} value less than about N_{d,0}−1 may be used. In another embodiment, the Nₑ value may be greater than about 1.2 and an N_{d} value less than about N_{d,0}−1.2.

In one embodiment, the one or more compounds of formula (I) is selected from the group consisting of:

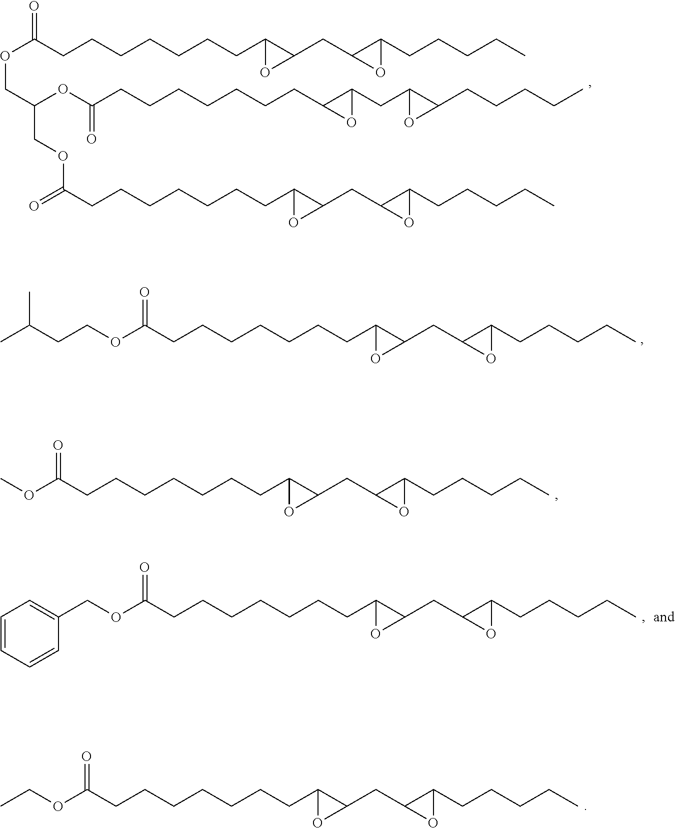

The epoxidized vegetable oil, an epoxidized fatty acid or epoxidized fatty ester may be in present in any suitable amount in the composition. The epoxidized vegetable oil, epoxidized fatty acid, and/or epoxidized fatty ester may be present anywhere between 1% to 99% of the composition. For example, the epoxidized vegetable oil, epoxidized fatty acid, and/or epoxidized fatty ester may be less than about 5 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or about 99 wt %. The range of the wt % of the epoxidized vegetable oil, epoxidized fatty acid, and/or epoxidized fatty ester may be present in the composition between 10 to 90 wt %. In one embodiment, the epoxidized vegetable oil, epoxidized fatty acid, and/or epoxidized fatty ester is present in the composition in an amount of from 25 to 75 wt %. In another embodiment, the epoxidized vegetable oil, epoxidized fatty acid, and/or epoxidized fatty ester is present in the composition in an amount of from 30 to 55 wt %.

The asphalt pavement product according to the present application can contain from about 0 wt % to about 5 wt % of one or more stabilizers. For example, the asphalt pavement product of the present application can contain one or more stabilizers in the amount of from about 0.01 wt % to about 5 wt %, about 0.01 wt % to about 4 wt %, about 0.01 wt % to about 3 wt %, about 0.1 wt % to about 3 wt %, about 0.2 wt % to about 3 wt %, about 0.3 wt % to about 3 wt %, about 0.4 wt % to about 3 wt %, about 0.5 wt % to about 3 wt %, about 0.6 wt % to about 3 wt %, about 0.7 wt % to about 3 wt %, about 0.8 wt % to about 3 wt %, about 0.9 wt % to about 3 wt %, about 1 wt % to about 3 wt %, about 0.01 wt % to about 2 wt %, about 0.1 wt % to about 2 wt %, about 0.2 wt % to about 2 wt %, about 0.3 wt % to about 2 wt %, about 0.4 wt % to about 2 wt %, about 0.5 wt % to about 2 wt %, about 0.6 wt % to about 2 wt %, about 0.7 wt % to about 2 wt %, about 0.8 wt % to about 2 wt %, about 0.9 wt % to about2 wt %, about 1 wt % to about 2 wt %, about 0.01 wt % to about 1 wt %, about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt %, about 0.8 wt % to about 1 wt %, or about 0.9 wt % to about 1 wt %.

Suitable stabilizers that can be used in accordance with the present application can be

selected from the group consisting of gums, acacia gum, cellulose gum, guar gum, locust bean gum, xanthan gum, agar, alginic acid, sodium alginate, potassium alginate, ammonium alginate, calcium alginate, polysaccharides from brown algae, casein, collagen, albumin, pectin, gelatin, polyvinyl alcohol, polyurethanes, acrylic polymers, latex, styrene/butadiene polymer, carboxymethyl cellulose, hypromellose, gluten, hydroxyethyl methyl cellulose, attapulgite, bentonite, sodium salts, calcium salts, carrageenan, pullulan, konjac, alginate, modified castor oil, silicone resins, dimethicones, modified silicones, and a combination thereof.

The asphalt pavement product according to the present application can further comprise one or more rejuvenators and/or one or more softening agent. Rejuvenators and softening agents have been successfully implemented to offset the high stiffness and low creep rate of aged recycled asphalt pavement (RAP). Use of rejuvenators and/or softening agents has resulted in considerable improvement to low-temperature mix properties of mixtures with high RAP content (Hajj et al., “Influence of Hydrogreen Bioasphalt on Viscoelastic Properties of Reclaimed Asphalt Mixtures,” Transportation Research Record: Journal of the Transportation Research Board 2371:13-22 (2013); Shen et al., “Effects of Rejuvenating Agents on Superpave Mixtures Containing Reclaimed Asphalt Pavement,” Journal of Materials in Civil Engineering 19(5):376-384 (2007); and Zaumanis et al., “Influence of Six Rejuvenators on the Performance Properties of Reclaimed Asphalt Pavement (RAP) Binder and 100% Recycled Asphalt Mixtures,” Construction and Building Materials 71:538-550 (2014), which are hereby incorporated by reference in their entirety).

Rejuvenators and/or softening agents are chemical or bio-derived additives which typically contain a high proportion of maltenes, which serves to replenish the maltene content in the aged bitumen that has been lost as a result of oxidation leading to increased stiffness (Copeland, A., “Reclaimed Asphalt Pavement in Asphalt Mixtures: State of the Practice,” (2011), which is hereby incorporated by reference in its entirety). Binder aging is characterized by a change of the maltenes fraction into asphaltene through oxidation. The amount of asphaltene is related to the viscosity of asphalt (Firoozifar et al., “The Effect of Asphaltene on Thermal Properties of Bitumen,” Chemical Engineering Research and Design 89:2044-2048 (2011), which is hereby incorporated by reference in its entirety). The addition of maltenes helps rebalance the chemical composition of the aged bitumen, which contain a high percentage of asphaltenes (causing high stiffness and low creep rate). Rejuvenators and softening agents recreate the balance between the asphaltene and maltene by providing more maltenes and/or by allowing better dispersion of the asphaltenes (Elseifi et al., “Laboratory Evaluation of Asphalt Mixtures Containing Sustainable Technologies,” Journal of the Association of Asphalt Paving Technologists 80 (2011), which is hereby incorporated by reference in its entirety). Rejuvenators are added during mixing and are believed to diffuse within the aged bitumen imparting softening characteristics. The rejuvenator initially coats the outside of the RAP aggregates before they gradually seep into the aged bitumen layer until they diffuse through the film thickness (Carpenter et al., “Modifier Influence in the Characterization of Hot-Mix Recycled Material,” Transportation Research Record 777 (1980), which is hereby incorporated by reference in its entirety). In some embodiments, the rejuvenator is selected from the group consisting of SESO, Hydrolene®, soybean oil, EMS, lineceed oil derivatives, heat bodied vegetable oils, ANOVA®, EvoFlex®, EvoFlex® CA (EvoFlex® CA-7), JIVER, EVERSOL®, Revive®, ACF 2000, RAPpave®, ReGen®, Delta S®, RP1000, and HydroGreen®.

The asphalt pavement product according to the present application can further comprise one or more asphalt binders. The asphalt binders that can be used according to this application include, but are not limited to, materials acquired from asphalt producing refineries, flux, refinery vacuum tower bottoms, pitch, and other residues of processing of vacuum tower bottoms.

In some embodiments, the asphalt binder is selected from the group consisting of PG 52-34, PG 58-34, PG 64-28, PG 70-28, PG 76-28, PG 70-22, and PG 76-22.

In some embodiments, the asphalt pavement product further includes one or more colorants. The colorant can include a metal oxide compound, such as titanium dioxide (white), zinc ferrite (yellow), red iron oxides, chrome oxide (green), and ultramarine (blue), silver oxide (black), zinc oxide (dark green), or the like. In another embodiment, the colorant or other material may not be a metal-oxide compound. Preferably, the one or more colorants is selected from the group consisting of iron oxide, titanium dioxide, azo pigments, phthalocyanine pigments, anthraquinone pigments, lead chromate, lead molybdate, cadmium red, prussian blue, ultramarine, cobalt blue, chrome green, zinc oxide, and a combination thereof.

In some embodiments, the asphalt pavement product further includes one or more antimicrobials. The one or more antimicrobials of any embodiments described herein is selected from the group consisting of poly [oxyyethylene (dimethyliminio) ethylene (dimethyliminio) ethylene dichloride], chitin, chitosan, citric acid, C₁₂₋₁₈-benzalkonium chloride, isopropyl alcohol, potassium tetraborate, elemental copper, elemental silver, colloidal silver, elemental zinc, and a combination thereof.

In some embodiments, the asphalt pavement product further includes one or more crosslinkers. The one or more crosslinkers of any embodiments described herein is selected from the group consisting of elemental sulfur, hexamethylene diisocyanate, isophorone diisocyanate, methyl isocyanate, methylenebis(phenyl isocyanate), naphthalene diisocyanate, toluene-2,4-diisocyanate, hexane dithiol, trithiols, polyphsophoric acid, and a combination thereof.

In some embodiments, the asphalt pavement product further includes one or more antistripping agents. The one or more antistripping agents of any embodiments described herein is selected from the group consisting of organosilane compounds, polyamine agents, amidoamine compounds, lime based antistripping agents, and a combination thereof.

In some embodiments, the asphalt pavement product further includes one or more wetting agents. Wetting agents that can be used according to the present application include silicone-free alkoxylated alcohol surfactant, self-emulsifiable wetting agents based on acetylenic diol chemicals, e.g. SE-F (Air Products and Chemicals, Inc.), ethoxylated acetylenic diols, alkylphenyl ethoxylate, acetylenic diol chemicals, ethoxylated nonionic fluorosurfactant, branched secondary alcohol ethoxylates, nonionic surfactants, secondary alcohol ethoxylate ethoxylated alcohol, ethoxylated acetylenic diol surfactant, polyethylene glycol alkyl ether, propylene glycol alkyl ether, glucoside alkyl ether, polyethylene glycol octyl phenyl ether, polyethylene glycol alkyl phenyl ether, glycerol alkyl ester, polyoxyethylene glycol sorbitan alkyl esters, sorbitan alkyl esters, cocamide monoethanolamine, cocamide diethanolamine, dodecyldimethylamine oxide, polyethylene glycol and polypropylene glycol block copolymers, polyethoxylated tallow amines, fluorosurfactants, alkyl carboxylate, alkyl polyacrylic salt, alkyl sulfate, alkyl phosphate, alkyl dicarboxylate, alkyl disulfate, alkyl diphosphate, alkoxy carboxylate, alkoxy sulfate, alkoxy phosphates, alkoxy dicarboxylates, alkoxy disulfates, alkoxy diphosphates, substituted aryl carboxylates, substituted aryl sulfates, substituted aryl phosphates, substituted aryl dicarboxylates, substituted aryl disulfates, substituted aryl diphosphates, halides of a molecule comprising a hydrophobic chain and a cationic charge center selected from the group consisting of amine, quaternary ammonium, benzalkonium and alkylpyridinium ions. In one embodiment, the one or more wetting agents is selected from the group consisting of ethoxylated acetylenic surfactant, Gemini surfactants, C₂-C₁₈ alkyl/alkylene/alkylyne straight or branched chain polyols, ethoxylates, ethoxysulfates, sulfates, sulfonates, carboxylates, polyoxyethylene surfactants, and a combination thereof. In another embodiment, the wetting agent is ethoxylated acetylenic surfactant (Surfonyl 485)

In some embodiments, the asphalt pavement product further includes one or more chemical additives. Suitable chemical additives that can be used include, but are not limited to, lime, cement, or fly ash.

Another aspect of the present application relates to a method of paving a road course. This method comprises:
providing a road course;
applying a layer of the asphalt pavement product of any of the embodiments described herein to the road course;
compacting the layer of the asphalt pavement product; and
curing the layer of the asphalt pavement product under conditions effective to form a paved road course.

The road course that can be paved according to the present application can be selected from the group consisting of unpaved surface, old asphalt pavement, compacted subgrade, subbase course, base course, binder course, or surface course.

In one embodiment, the method of paving a road course further comprises:
applying a layer of gravel to the road course to form a gravel sublayer on the road course prior to said applying the asphalt pavement product.

In another embodiment, the method of paving a road course further comprises:
compacting the gravel sublayer prior to said applying the asphalt pavement product.

The paved road course prepared using the methods described in the present application has an indirect tensile strength of from about 200 kPa to about 4000 kPa, about 300 kPa to about 3500 kPa, about 400 kPa to about 3500 kPa, about 400 kPa to about 3000 kPa, about 400 kPa to about 2500 kPa, about 400 kPa to about 2000 kPa, about 400 kPa to about 1900 kPa, about 400 kPa to about 1800 kPa, about 400 kPa to about 1700 kPa, about 400 kPa to about 1600 kPa, about 400 kPa to about 1500 kPa, about 500 kPa to about 3500 kPa, about 500 kPa to about 3000 kPa, about 500 kPa to about 2500 kPa, about 500 kPa to about 2000 kPa, about 500 kPa to about 1900 kPa, about 500 kPa to about 1800 kPa, about 500 kPa to about 1700 kPa, about 500 kPa to about 1600 kPa, about 500 kPa to about 1500 kPa, about 600 kPa to about 3000 kPa, about 600 kPa to about 2500 kPa, about 600 kPa to about 2000 kPa, about 600 kPa to about 1900 kPa, about 600 kPa to about 1800 kPa, about 600 kPa to about 1700 kPa, about 600 kPa to about 1600 kPa, about 600 kPa to about 1500 kPa, about 700 kPa to about 3000 kPa, about 700 kPa to about 2500 kPa, about 700 kPa to about 2000 kPa, about 700 kPa to about 1900 kPa, about 700 kPa to about 1800 kPa, about 700 kPa to about 1700 kPa, about 700 kPa to about 1600 kPa, about 700 kPa to about 1500 kPa, about 800 kPa to about 3000 kPa, about 800 kPa to about 2500 kPa, about 800 kPa to about 2000 kPa, about 800 kPa to about 1900 kPa, about 800 kPa to about 1800 kPa, about 800 kPa to about 1700 kPa, about 800 kPa to about 1600 kPa, or about 800 kPa to about 1500 kPa.

The paved road course prepared using the methods described in the present application can has a compacted density of from about 100 lb/ft³ to about 145 lb/ft³, about 110 lb/ft³ to about 145 lb/ft³, about 120 lb/ft³ to about 145 lb/ft³, about 120 lb/ft³ to about 144 lb/ft³, about 120 lb/ft³ to about 143 lb/ft³, about 120 lb/ft³ to about 142 lb/ft³, about 120 lb/ft³ to about 141 lb/ft³, about 120 lb/ft³ to about 140 lb/ft³, about 122 lb/ft³ to about 145 lb/ft³, about 122 lb/ft³ to about 144 lb/ft³, about 122 lb/ft3 to about 143 lb/ft³, about 122 lb/ft³ to about 142 lb/ft³, about 122 lb/ft³ to about 141 lb/ft³, about 122 lb/ft³ to about 140 lb/ft³, about 124 lb/ft³ to about 145 lb/ft³, about 124 lb/ft³ to about 144 lb/ft³, about 124 lb/ft³ to about 143 lb/ft³, about 124 lb/ft³ to about 142 lb/ft³, about 124 lb/ft³ to about 141 lb/ft³, about 124 lb/ft³ to about 140 lb/ft³, about 126 lb/ft³ to about 145 lb/ft³, about 126 lb/ft³ to about 144 lb/ft³, about 126 lb/ft³ to about 143 lb/ft³, about 126 lb/ft³ to about 142 lb/ft³, about 126 lb/ft³ to about 141 lb/ft³, about 126 lb/ft³ to about 140 lb/ft³, about 128 lb/ft³ to about 145 lb/ft³, about 128 lb/ft³ to about 144 lb/ft³, about 128 lb/ft³ to about 143 lb/ft³, about 128 lb/ft³ to about 142 lb/ft³, about 128 lb/ft³ to about 141 lb/ft³, about 128 lb/ft³ to about 140 lb/ft³, about 130 lb/ft³ to about 145 lb/ft³, about 130 lb/ft³ to about 144 lb/ft³, about 130 lb/ft³ to about 143 lb/ft³, about 130 lb/ft³ to about 142 lb/ft³, about 130 lb/ft³ to about 141 lb/ft3, or about 130 lb/ft³ to about 140 lb/ft³.

Another aspect of the present application relates to a method of paving a road course comprising:
providing a road course;
providing a reclaimed asphalt pavement product (RAP);
applying a layer of the RAP on the road course to form a RAP layer;
applying an emulsified product on the RAP layer to form a rejuvenated RAP layer in the road course, said emulsified product comprising:
   water;
   one or more surfactants;
   one or more stabilizers;
   one or more polymers; and
   one or more compounds of formula (I):

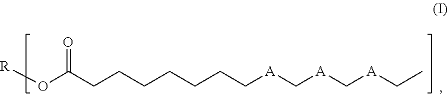

wherein:
each A is selected independently at each occurrence thereof from the group consisting of

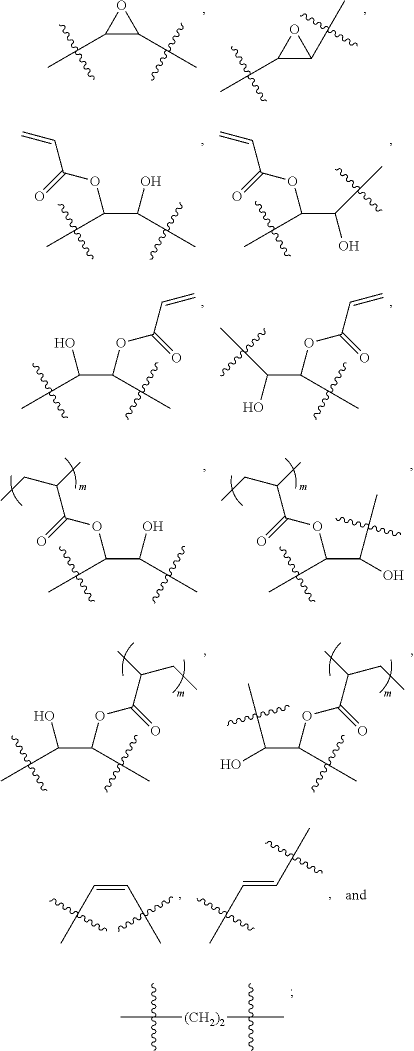

and
wherein at least one A is

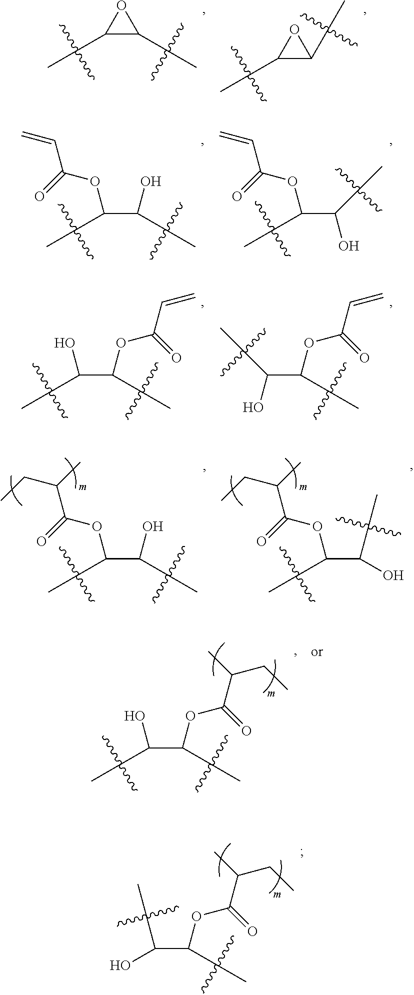

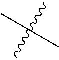

each represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of

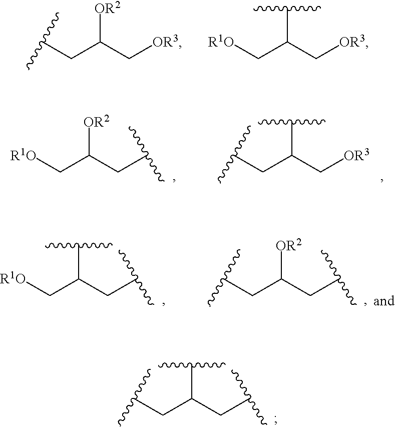

each

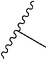

represents the point of attachment to a

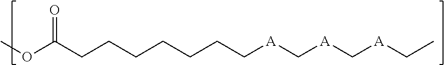

moiety;
R¹, R², and R³ are independently selected from the group consisting of —H and —C(O)R⁴;
R⁴ is H, C₁-C₂₃ alkyl, or aryl;
compacting the rejuvenated RAP layer to form a rejuvenated RAP course; and
curing the rejuvenated RAP course under conditions effective to form a paved road course.

In one embodiment, method of paving a road course further comprises: applying a layer of gravel to the road course to form a gravel sublayer prior to said applying the RAP layer.

In another embodiment, the method of paving a road course further comprises: compacting the gravel sublayer prior to said applying the RAP layer.

Another aspect of the present application relates to a method of paving a road course. This method comprises:
providing a road course;
providing a reclaimed asphalt pavement product (RAP);
mixing the RAP with an emulsified product to form a rejuvenated RAP mixture, said emulsified product comprising:
   water;
   one or more surfactants;
   one or more stabilizers;
   one or more polymers; and
   one or more compounds of formula (I):

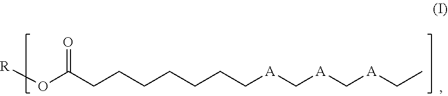

wherein:
each A is selected independently at each occurrence thereof from the group consisting of

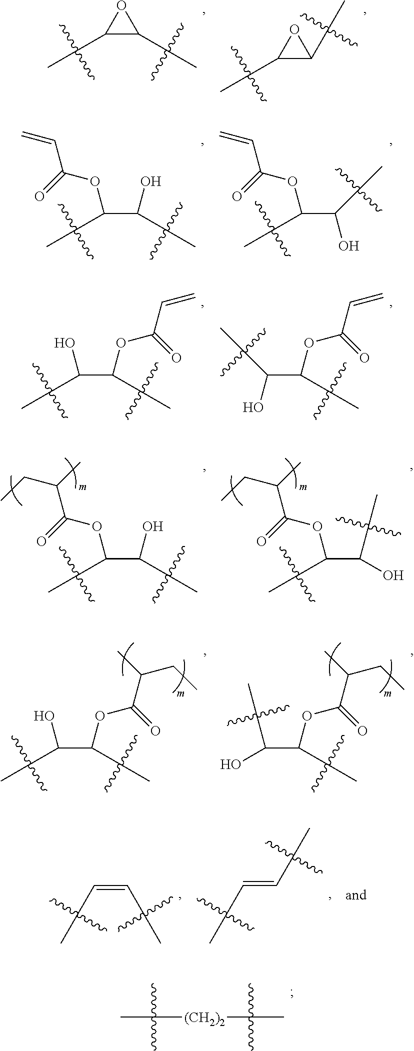

and
wherein at least one A is

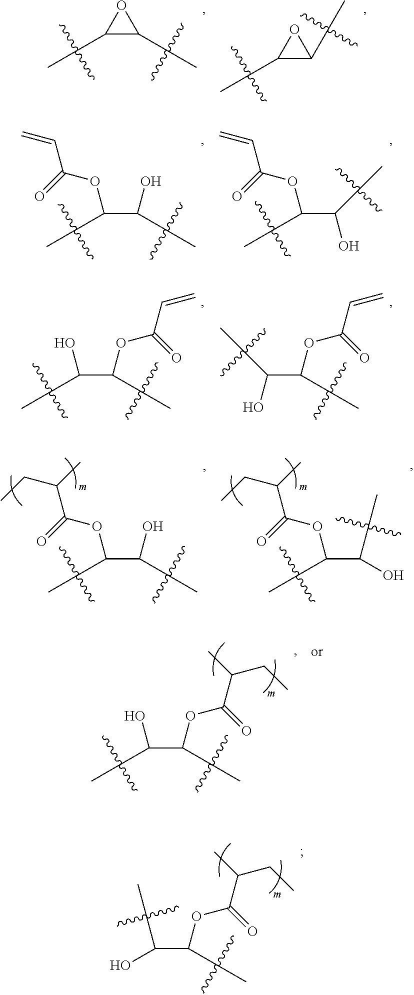

each

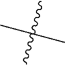

represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or

R is selected from the group consisting of

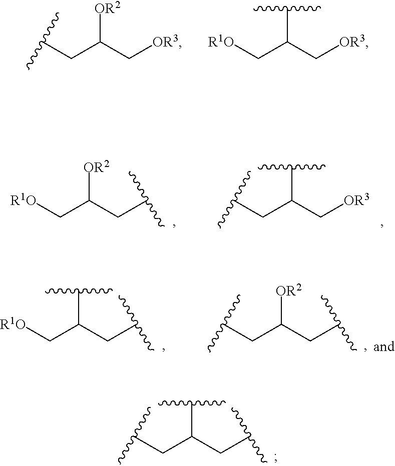

each

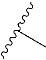

represents the point of attachment to a

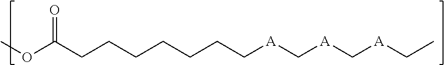

moiety;
R¹, R², and R³ are independently selected from the group consisting of —H and —C(O)R⁴;
R⁴ is H, C₁-C₂₃ alkyl, or aryl;
applying a layer of the rejuvenated RAP mixture on the road course to form a rejuvenated RAP layer;
compacting the rejuvenated RAP layer to form a rejuvenated RAP course; and
curing the rejuvenated RAP course under conditions effective to form a paved road course.

In one embodiment, method of paving a road course further comprises: applying a layer of gravel to the road course to form a gravel sublayer prior to said applying the layer of the rejuvenated RAP mixture.

In another embodiment, method of paving a road course further comprises: compacting the gravel sublayer prior to said applying the layer of the rejuvenated RAP mixture.

The above disclosure is general. A more specific description is provided below in the following examples. The examples are described solely for the purpose of illustration and are not intended to limit the scope of the present application. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present application, but are not intended to limit the scope of the claimed application.

### Example 1—BioMAG Synthesis

### Acrylation of Epoxidized High Oleic Soybean Oil

A mixture of acrylated epoxidized high oleic soybean oil and sub-epoxidized soybean oil (AEHOSO/SESO) was prepared as follows. Acrylic acid (AA), hydroquinone (HQ), and triethylamine (TEA) were purchased from Sigma Aldrich and used as received. Epoxidized high oleic soybean oil (EHOSO) was purchased from CHS Inc. (Mankato, MN) and used as received. Sub-epoxidized soybean oil (SESO, 2.3 wt % oxirane) was purchased from CHS Inc. and used as received. EHOSO (1 eq.), AA (3.15 eq.), HQ (1.4 eq.), and TEA (0.7 eq.) were combined and kept at 110 ° C. for 2 hours at 300 rpm stir rate. SESO (1 eq.) was then added to the mixture, followed by an additional 2 hours at 110 ° C. and 300 rpm. Complete esterification of AA was confirmed by ¹H-NMR.

### Chain Transfer Agent

The synthesis of the dibenzyl carbonotrithioate (OXCART) CTA was performed as described in U.S. Pat. No. 10,968,173 to Cochran et al. and Forrester et al., “RAFT Thermoplastics From Glycerol: a Biopolymer for Development of Sustainable Wood Adhesives,” Green Chemistry 22:6148-6156 (2020), which are hereby incorporated by reference in their entirety. Briefly, acetone, potassium phosphate (1.1 eq.), and benzyl mercaptan (1 eq.) were mixed together for 10 minutes. A constant temperature (25° C.) was maintained throughout the reaction. Carbon disulfide (1.7 eq.) was added and the reaction mixture was mixed for 10 minutes. Subsequently, benzyl bromide (1.05 eq.) was added and the reaction mixture was mixed for 10 minutes. The reaction mixture was then filtered and dried under reduced pressure to yield the product. ¹H-NMR was used to confirm structure and purity.

### RAFT Polymerization of AEHOSO

AEHOSO/SESO (454 eq.), OXCART (1 eq.), and 2,2′-azodi(2-methylbutyronitrile) (AMBN) (10.5 eq.) were mixed in a vessel and then sparged with nitrogen for 1 hour at room temperature. Subsequently, the temperature was increased to 105 ° C. and the reaction mixture was kept at 105 ° C. for 4 hours. The polymerization was then terminated through the introduction of phenothiazine (20 eq.). The resultant mixture (BioMAG, poly(acrylated epoxidized high oleic soybean oil) in SESO) showed 62% conversion of acrylic bonds.

### Example 2—Preparation of BioMAG Emulsion (BME)

### Preparation of BioMAG Emulsion #1 (BME1)

BioMAG (144 g), soy lecithin (24 g) (Yelkin TS), and Surfynol 440 (24 g) were added to round bottom flask equipped with a mechanical agitator and mixed for 15 minutes at 300 RPM. Water (192 g) was added to the flask and the mixture was agitated at 3600 RPM for 120 minutes. A mixture of Beckosol AQ surfactant (2.4 g) (Polynt Composites) in water (93.12 g) agitated for 30 minutes was then added to the reaction mixture. The resultant solution was diluted to 3 (BME1A) or 6 (BME1B) vol % BioMAG with water for use in RAP sample preparation.

### Preparation of BioMAG Emulsion #2 (BME2)

To a 250 mL beaker containing BME2A (4.5 g) or BME2B (9 g) of BioMAG emulsion, cationic polymer modified asphalt emulsion (30 g) was added over the course of 10 minutes with magnetic stirring (100 RPM). The mixture was stirred for an additional 30 minutes. The resultant solution was diluted to 3 vol % (BME2A) or 6 vol % (BME2B) BioMAG with water for use in RAP sample preparation.

### Example 3—Reclaimed Asphalt Pavement (RAP) Sample Preparation Using Gyratory Compaction

RAP (obtained from a supplier in Decorah, Iowa) was pre-sieved through a ½″ sieve. RAP was pre-dried in a temperature-controlled oven at 50° C. for 48 hours prior to usage. Samples were prepared in accordance with AASHTO PP 86-20, Standard Practice for Emulsified Asphalt Content of Cold Recycled Mixture Designs. For the control samples, RAP (1250 g) and DI water (1, 3, 6, or 9% w/w) were mixed thoroughly for two minutes and added to the gyratory compactor apparatus (100 mm mold). Similarly, samples containing either BioMAG emulsion I, BioMAG emulsion II, or cationic polymer modified asphalt emulsion (CPMAE) utilized RAP (1250 g) with DI water (5% w/w) and the requisite emulsion tested (4.5% w/w) mixed thoroughly for two minutes prior to addition into the gyratory compactor. Samples were compacted for 75 gyrations using the 100 mm mold and cured overnight at 50 ° C. for 48 hours and then tested in accordance with ASTM D6931, Standard Method for Indirect Tensile (IDT) Strength of Asphalt Mixtures (Table 1). The results indicate that that BME1B and BME2B treated RAP samples are approximately 15% and 37% stronger than those treated by CPMAE alone. This suggests that CPMAE, a “mortar-like” material, provides comparatively less cohesion to compacted RAP samples than those treated with appropriate quantities of BioMAG emulsion I or BioMAG emulsion II. This may be interpreted as the failure of emulsified asphalt particles to soften the RAP granules through the treatment and compaction process (FIG. 2A). Accordingly, strength in CPMAE-treated RAP is generated primarily through cohesive forces that develop between the CPMAE and RAP granules. Conversely, samples treated by RRA-type recycling aides like BioMAG Emulsion I or BioMAG Emulsion II facilitate the softening of the RAP granules such that they deform more easily during compaction (FIG. 2B). This process permits better cohesion between RAP granules.

TABLE 1
Indirect Tensile Strength Data for
Laboratory Compacted Specimens

| | | Emulsion | IDT | Mean |
|---|---|---|---|---|
| Recycling | Compaction | concentration, | Strength | IDT |
| Aid | Temperature, ° C. | wt % (in RAP) | (kPa) | (kPa) |
| None | 135 | 0 | 910 | 1415 |
| None | 135 | 0 | 1495 | |
| None | 135 | 0 | 1334 | |
| None | 25 | 0 | 165 | 134 |
| None | 25 | 0 | 129 | |
| None | 25 | 0 | 109 | |
| Water | 25 | 3 | 186 | 175 |
| Water | 25 | 3 | 154 | |
| Water | 25 | 3 | 184 | |
| Water | 25 | 6 | 342 | 356 |
| Water | 25 | 6 | 373 | |
| Water | 25 | 6 | 354 | |
| CPMAE | 25 | 4.5 | 421 | 397 |
| CPMAE | 25 | 4.5 | 365 | |
| CPMAE | 25 | 4.5 | 405 | |
| BME1A | 25 | 4.5 | 317 | 328 |
| BME1A | 25 | 4.5 | 333 | |
| BME1A | 25 | 4.5 | 335 | |
| BME1B | 25 | 4.5 | 511 | 458 |
| BME1B | 25 | 4.5 | 407 | |
| BME1B | 25 | 4.5 | 457 | |
| BME2A | 25 | 4.5 | 365 | 352 |
| BME2A | 25 | 4.5 | 352 | |
| BME2A | 25 | 4.5 | 340 | |
| BME2B | 25 | 4.5 | 565 | 543 |
| BME2B | 25 | 4.5 | 548 | |
| BME2B | 25 | 4.5 | 517 | |

### Example 4—Field Tests

### Field Test, Postville, IA

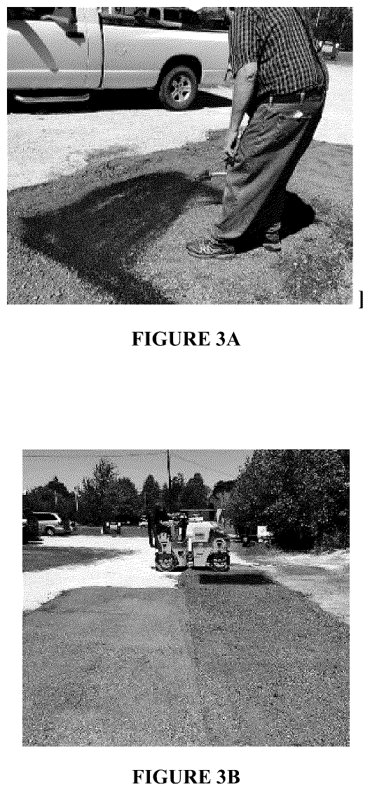

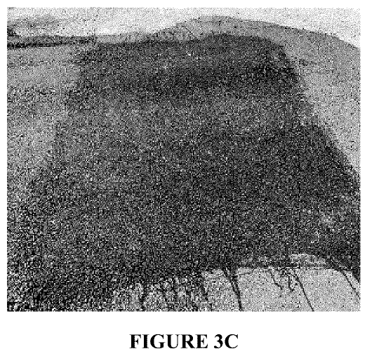

RAP (obtained from a supplier in Postville, IA) was pre-sieved through a ½″ sieve. RAP was placed onto a prepared subgrade at 420 pounds per square yard and compacted with a 4 ton compactor as shown in FIG. 3B. The area was subdivided into 4 yd² plots and treated with various recycling aids to a total dose rate of 19.8 pounds per square yard (4.5 wt %) (FIGS. 3A, 3C). After four weeks, core samples were collected and tested for IDT (Table 2).

TABLE 2
IDT Results for Four Test Sections Placed in Postville, IA

| | | Average |
|---|---|---|
| | IDT | IDT |
| Recycling | Strength | Strength |
| Aid | (kPa) | (kPa) |
| CPMAE | 94 | 161 |
| CPMAE | 228 | |
| BME1A | 237 | 307 |
| BME1A | 378 | |
| BME1B | 632 | 571 |
| BME1B | 667 | |
| BME1B | 472 | |
| BME1B | 515 | |
| BME2A | 406 | 337 |
| BME2A | 372 | |
| BME2A | 231 | |

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. An asphalt pavement product comprising:
a reclaimed asphalt pavement product (RAP); and
an emulsified product mixed with the RAP, said emulsified product comprising:
water, one or more surfactants;
one or more stabilizers;
one or more polymers; and
one or more compounds of formula (I): 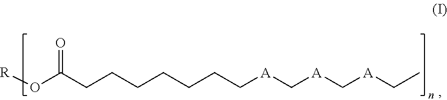
wherein:
each A is selected independently at each occurrence thereof from the group consisting of 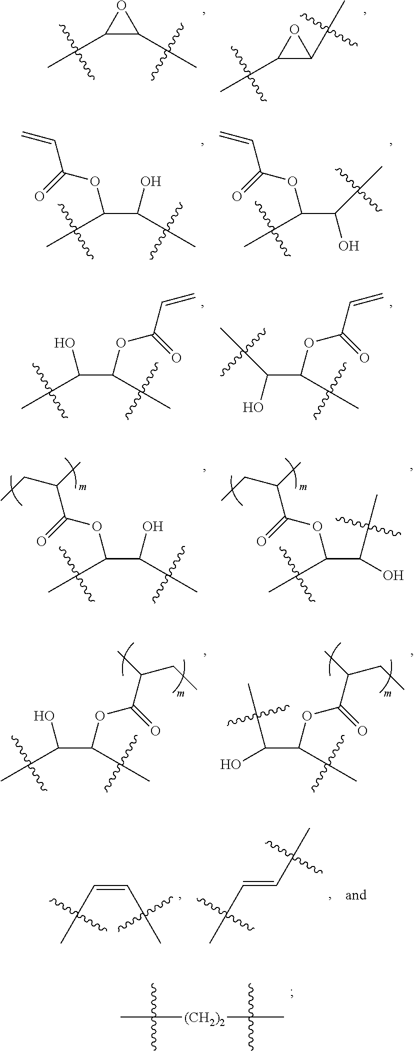
and wherein at least one A is 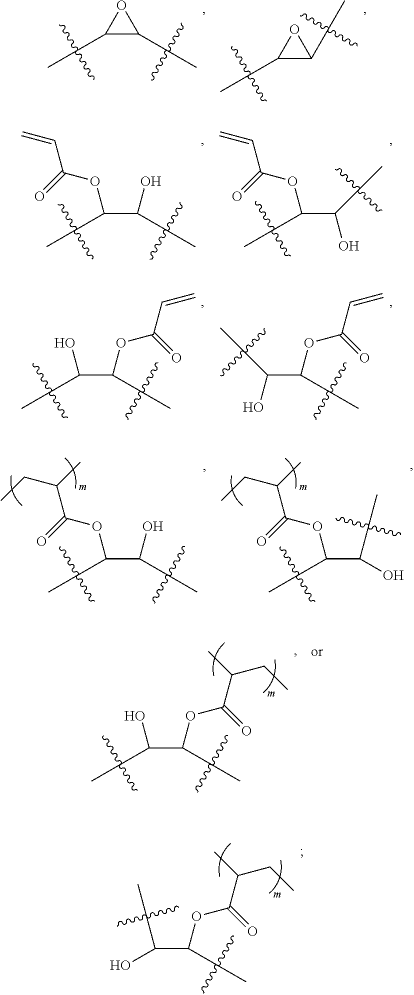
each 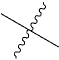
represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of 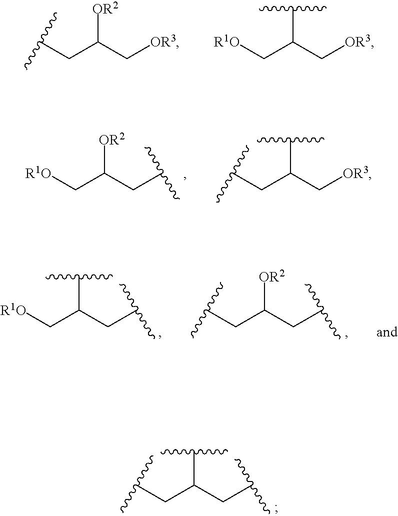
each 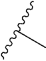
represents the point or attachment to a 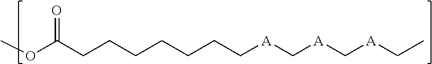
moiety;
R¹, R², and R³ are independently selected from the group consisting of —H and —C(O)R⁴;
R⁴ is H, C₁-C₂₃ alkyl, or aryl; and
wherein the reclaimed asphalt pavement product (RAP) is present in the asphalt pavement product in an amount of from about 80 wt % to about 100 wt %.

2. The asphalt pavement product of claim 1 further comprising:
one or more rejuvenators.

3. The asphalt pavement product of claim 1 further comprising:
one or more asphalt binders.

4. The asphalt pavement product of claim 1, wherein the reclaimed asphalt pavement product (RAP) is provided in the form of 0.5 to 1 inch diameter millings.

5. The asphalt pavement product of claim 1, wherein the one or more surfactants is selected from the group consisting of cationic emulsifying agents, anionic emulsifying agents, nonionic emulsifying agents, lecithin, and a combination thereof.

6. The asphalt pavement product of claim 1, wherein the one or more polymers is selected from the group consisting of styrene butadiene copolymers, polyethylene, cross-linked polyethylene, polypropylene, polybutadiene, polyisoprene, polyethylene terephthalate, polyvinyl alcohol, butyl acrylate, ethyl acrylate, methyl acrylate, polyacetic acid copolymers, poly(acrylated epoxidized triglycerides), and a combination thereof.

7. The asphalt pavement product of claim 1, wherein the compound of formula (I) is selected from the group consisting of sub-epoxidized soybean oil (SESO), acrylated epoxidized soybean oil (AESO), epoxidized methyl soyate (EMS), poly(acrylated epoxidized high oleic soybean oil) (PAEHOSO), and a combination thereof.

8. The asphalt pavement product of claim 1, wherein the one or more compounds of formula (I) have an Nₑ value greater than about 1.0 and an N_{d} value less than about N_{d,0}−1.

9. The asphalt pavement product of claim 8, wherein the one or more compounds of formula (I) have an Nₑ value greater than about 1.2 and an N_{d} value less than about N_{d,0}−1.2.

10. The asphalt pavement product of claim 1, wherein the one or more stabilizers is selected from the group consisting of gums, acacia gum, cellulose gum, guar gum, locust bean gum, xanthan gum, agar, alginic acid, sodium alginate, potassium alginate, ammonium alginate, calcium alginate, polysaccharides from brown algae, casein, collagen, albumin, pectin, gelatin, polyvinyl alcohol, polyurethanes, acrylic polymers, latex, styrene/butadiene polymer, carboxymethyl cellulose, hypromellose, gluten, hydroxyethyl methyl cellulose, attapulgite, bentonite, sodium salts, calcium salts, carrageenan, pullulan, konjac, alginate, modified castor oil, silicone resins, dimethicones, modified silicones, and a combination thereof.

11. The asphalt pavement product of claim 1 further comprising:
one or more colorants.

12. The asphalt pavement product of claim 11, wherein the one or more colorants is selected from the group consisting of iron oxide, titanium dioxide, azo pigments, phthalocyanine pigments, anthraquinone pigments, lead chromate, lead molybdate, cadmium red, prussian blue, ultramarine, cobalt blue, chrome green, zinc oxide, and a combination thereof.

13. The asphalt pavement product of claim 1 further comprising:
one or more antimicrobials.

14. The asphalt pavement product of claim 13, wherein the one or more antimicrobials is selected from the group consisting of poly [oxyyethylene (dimethyliminio) ethylene (dimethyliminio) ethylene dichloride], chitin, chitosan, citric acid, C₁₂₋₁₈-benzalkonium chloride, isopropyl alcohol, potassium tetraborate, elemental copper, elemental silver, colloidal silver, elemental zinc, and a combination thereof.

15. The asphalt pavement product of claim 1 further comprising:
one or more crosslinkers.

16. The asphalt pavement product of claim 15, wherein the one or more crosslinkers is selected from the group consisting of elemental sulfur, hexane dithiol, trithiols, polyphsophoric acid, and a combination thereof.

17. The asphalt pavement product of claim 1 further comprising:
one or more antistripping agents.

18. The asphalt pavement product of claim 17, wherein the one or more antistripping agents is selected from the group consisting of organosilane compounds, polyamine agents, amidoamine compounds, lime based antistripping agents, and a combination thereof.

19. The asphalt pavement product of claim 1 further comprising:
one or more wetting agents.

20. The asphalt pavement product of claim 19, wherein the one or more wetting agents is selected from the group consisting of ethoxylated acetylenic surfactant, Gemini surfactants, C2-C18 alkyl/alkylene/alkylyne straight or branched chain polyols, ethoxylates, ethoxysulfates, sulfates, sulfonates, carboxylates, polyoxyethylene surfactants, and a combination thereof.

21. A method of paving a road course comprising:
providing a road course;
applying a layer of the asphalt pavement product of claim 1 to the road course;
compacting the layer of the asphalt pavement product; and
curing the layer of the asphalt pavement product under conditions effective to form a paved road course.

22.-25. (canceled)

26. A method of paving a road course comprising:
providing a road course;
providing a reclaimed asphalt pavement product (RAP);
applying a layer of the RAP on the road course to form a RAP layer;
applying an emulsified product on the RAP layer to form a rejuvenated RAP layer in the road course, said emulsified product comprising:
water;
one or more surfactants;
one or more stabilizers;
one or more polymers; and
one or more compounds of formula (I): 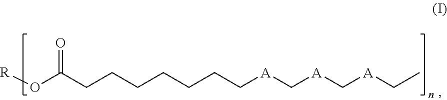
wherein:
each A is selected independently at each occurrence thereof from the group consisting of 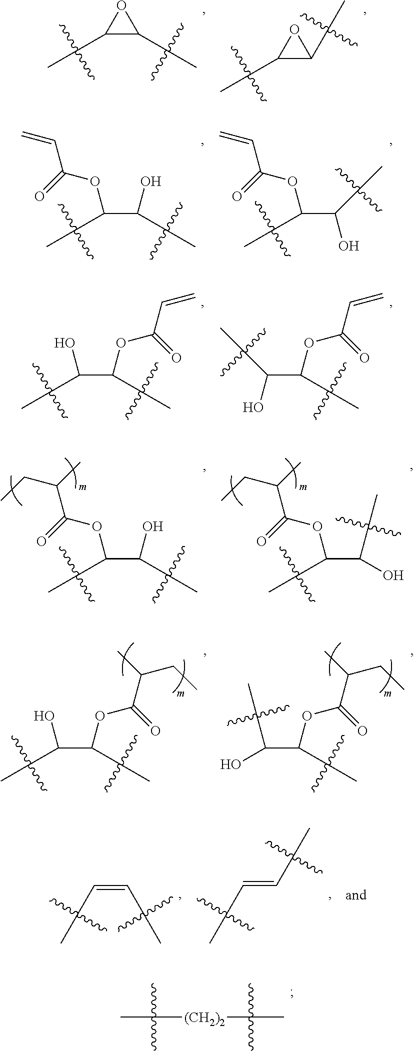
and
wherein at least one A is 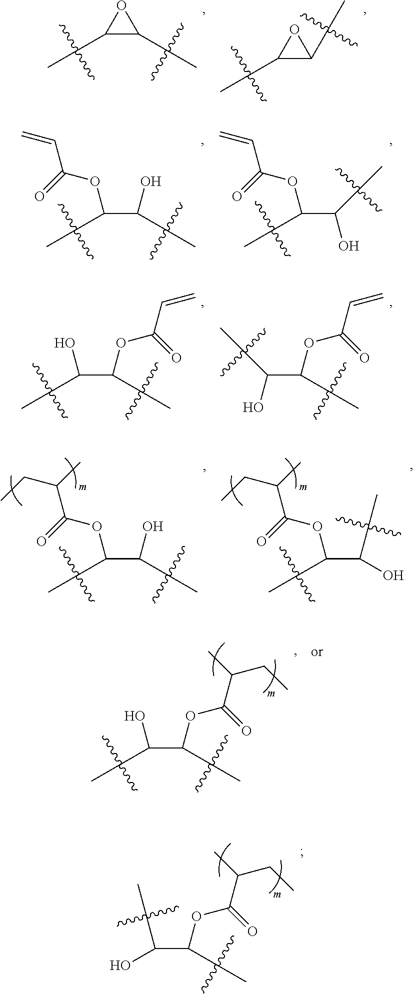
each 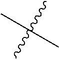
represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of 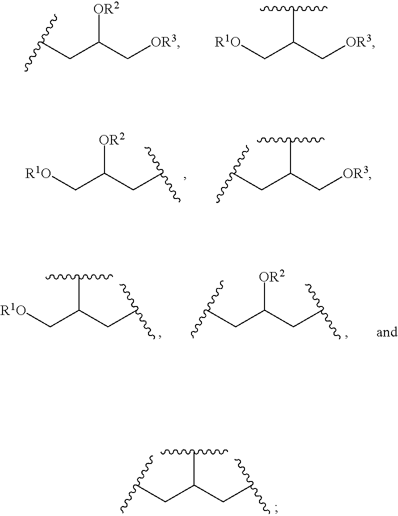
each 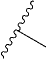
represents the point of attachment to a 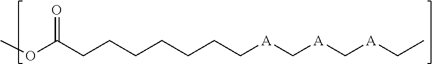
moiety;
R¹, R², and R³ are independently selected from the group consisting of —H and —C(O)R⁴;
R⁴ is H, C₁-C₂₃ alkyl, or aryl;
compacting the rejuvenated RAP layer to form a rejuvenated RAP course; and
curing the rejuvenated RAP course under conditions effective to form a paved road course.

27.-28. (canceled)

29. A method of paving a road course comprising:
providing a road course;
providing a reclaimed asphalt pavement product (RAP);
mixing the RAP with an emulsified product to form a rejuvenated RAP mixture, said emulsified product comprising:
water;
one or more surfactants;
one or more stabilizers;
one or more polymers; and
one or more compounds of formula (I): 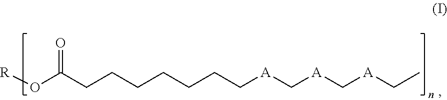
wherein:
each A is selected independently at each occurrence thereof from the group consisting of 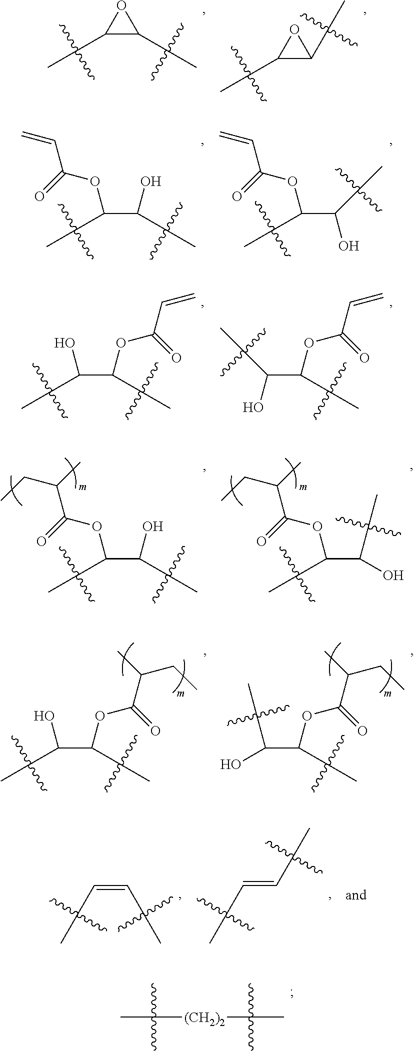
and
wherein at least one A is 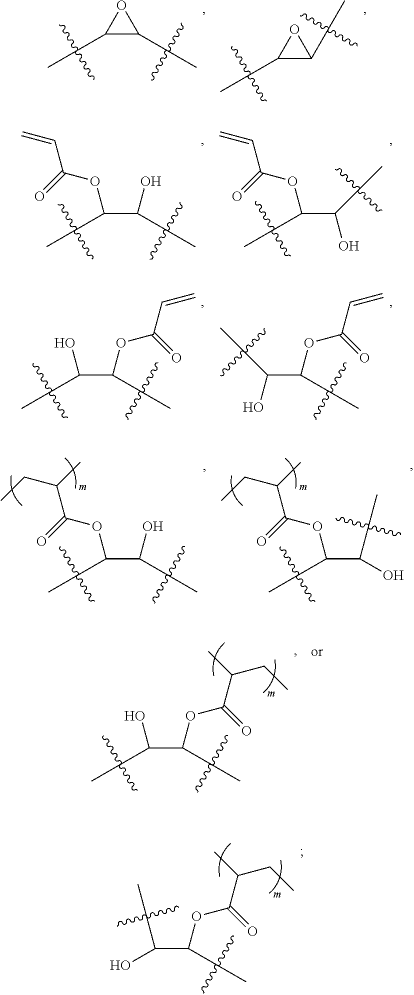
each 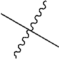
represents the point of attachment to a —CH₂— group;
n is 1, 2, or 3;
m is 1 to 100,000;
R is selected from the group consisting of H, C₁-C₂₃ alkyl, and benzyl, wherein the C₁-C₂₃ alkyl can be optionally substituted with an aryl, heteroaryl, or heterocyclyl; or
R is selected from the group consisting of 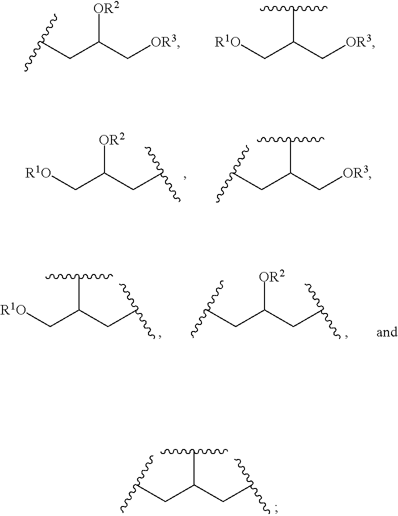
each 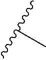
represents the point of attachment to a 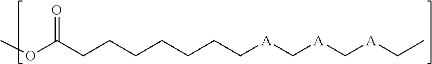
moiety;
R¹, R², and R³ are independently selected from the group consisting of —H and —C(O)R⁴;
R⁴ is H, C₁-C₂₃ alkyl, or aryl;
applying a layer of the rejuvenated RAP mixture on the road course to form a rejuvenated RAP layer,
compacting the rejuvenated RAP layer to form a rejuvenated RAP course; and
curing the rejuvenated RAP course under conditions effective to form a paved road course.

30.-41. (canceled)
